(19) United States
(12) Patent Application Publication
(10) Pub. No.: US 2023/0343050 A1
(43) Pub. Date: Oct. 26, 2023

(54) Systems and Methods for Providing User Experiences on AR/VR Systems

(71) Applicant: Meta Platforms Technologies, LLC, Menlo Park, CA (US)

(72) Inventors: Hyo Jin Kim, Redmond, WA (US); Tony Ng, London (GB); Vincent Lee, Seattle, WA (US); Florian Eddy Robert Ilg, Kirkland, WA (US); Sammy El Ghazzal, Unterengstringen (CH); Zijian Wang, Bothell, WA (US); Zhong Wang, Redmond, WA (US); Po-Kang Huang, Redmond, WA (US)

(21) Appl. No.: 18/305,073

(22) Filed: Apr. 21, 2023

Related U.S. Application Data
(60) Provisional application No. 63/335,111, filed on Apr. 26, 2022.
(60) Provisional application No. 63/359,993, filed on Jul. 11, 2022.
(60) Provisional application No. 63/492,451, filed on Mar. 27, 2023.

(51) Int. Cl. G06T 19/00; G06F 3/01; G02B 27/01

(52) U.S. Cl. CPC G06T 19/006; G06F 3/013; G02B 27/0172

(57) ABSTRACT

In one embodiment, an AR/VR system includes a social-networking application installed on the AR/VR system, which allows a user to access on online social network, including communicating with the user's social connections and interacting with content objects on the online social network. The AR/VR system also includes an AR/VR application, which allows the user to interact with an AR/VR platform by providing user input to the AR/VR application via various modalities. Based on the user input, the AR/VR platform generates responses and sends the generated responses to the AR/VR application, which then presents the responses to the user at the AR/VR system via various modalities.

### PRIORITY

This application claims the benefit under 35 U.S.C. § 119(e) of U.S. Provisional Patent Application No. 63/335,111, filed 26 Apr. 2022, U.S. Provisional Patent Application No. 63/359,993, filed 11 Jul. 2022, and U.S. Provisional Patent Application No. 63/492,451, filed 27 Mar. 2023, each of which is incorporated herein by reference.

### TECHNICAL FIELD

This disclosure generally relates to databases and file management within network environments, and in particular relates to application management for augmented-reality (AR) and virtual-reality (VR) systems.

### BACKGROUND

Augmented reality (AR) is an interactive experience of a real-world environment where the objects that reside in the real world are enhanced by computer-generated perceptual information, sometimes across multiple sensory modalities, including visual, auditory, haptic, somatosensory and olfactory. AR can be defined as a system that incorporates three basic features: a combination of real and virtual worlds, real-time interaction, and accurate 3D registration of virtual and real objects. The overlaid sensory information can be constructive (i.e. additive to the natural environment), or destructive (i.e. masking of the natural environment). This experience is seamlessly interwoven with the physical world such that it is perceived as an immersive aspect of the real environment. In this way, augmented reality alters one's ongoing perception of a real-world environment. Augmented reality is related to two largely synonymous terms: mixed reality and computer-mediated reality.

Virtual reality (VR) is a simulated experience that can be similar to or completely different from the real world. Applications of virtual reality include entertainment (particularly video games), education (such as medical or military training) and business (such as virtual meetings). Standard virtual reality systems use either virtual reality headsets or multi-projected environments to generate realistic images, sounds and other sensations that simulate a user's physical presence in a virtual environment. A person using virtual reality equipment is able to look around the artificial world, move around in it, and interact with virtual features or items. The effect is commonly created by VR headsets consisting of a head-mounted display with a small screen in front of the eyes but can also be created through specially designed rooms with multiple large screens. Virtual reality typically incorporates auditory and video feedback but may also allow other types of sensory and force feedback through haptic technology.

### BRIEF DESCRIPTION OF THE DRAWINGS

FIG. 1 illustrates an example network environment associated with an augmented-reality (AR)/virtual-reality (VR) system.

FIG. 2 illustrates an example augmented-reality (AR) system.

FIG. 3 illustrates an example virtual-reality (VR) system worn by a user.

FIG. 4 illustrates an example UI in a VR environment.

FIG. 5A illustrates an example process for processing an input image with our content-concealing visual descriptor.

FIG. 5B illustrates example comparisons of inversions.

FIG. 5C illustrates an example comparison of matches.

FIG. 6 illustrates an example architecture of our content-concealing NinjaNet encoder and an example transformation of a base descriptor.

FIG. 7 illustrates an example pipeline for training our content-concealing NinjaDesc.

FIG. 8 illustrates example qualitative results on landmark images.

FIG. 9 illustrates example HPatches evaluation results.

FIG. 10 illustrates and example generalization of our proposed adversarial descriptor learning framework across three different base descriptors.

FIG. 11 illustrates example qualitative reconstruction results on faces.

FIGS. 12A-12B illustrate example utility versus privacy trade-off analyses.

FIG. 13 illustrates example HPatches evaluation results.

FIG. 14 illustrates examples of NN attack.

FIG. 15 illustrates example distances to the original descriptor (SOSNet) of the nearest-neighbor retrieved by three variants of the oracle attack.

FIG. 16 illustrates examples of oracle attack with respect to number of neighbors.

FIG. 17 illustrates an example architecture of UNet.

FIG. 18 illustrates an example architecture of the descriptor inversion model based on UResNet used for the ablation study.

FIG. 19 illustrates an example generation of subtitles.

FIG. 20 illustrates an example computer system.

### DESCRIPTION OF EXAMPLE EMBODIMENTS

### System Overview

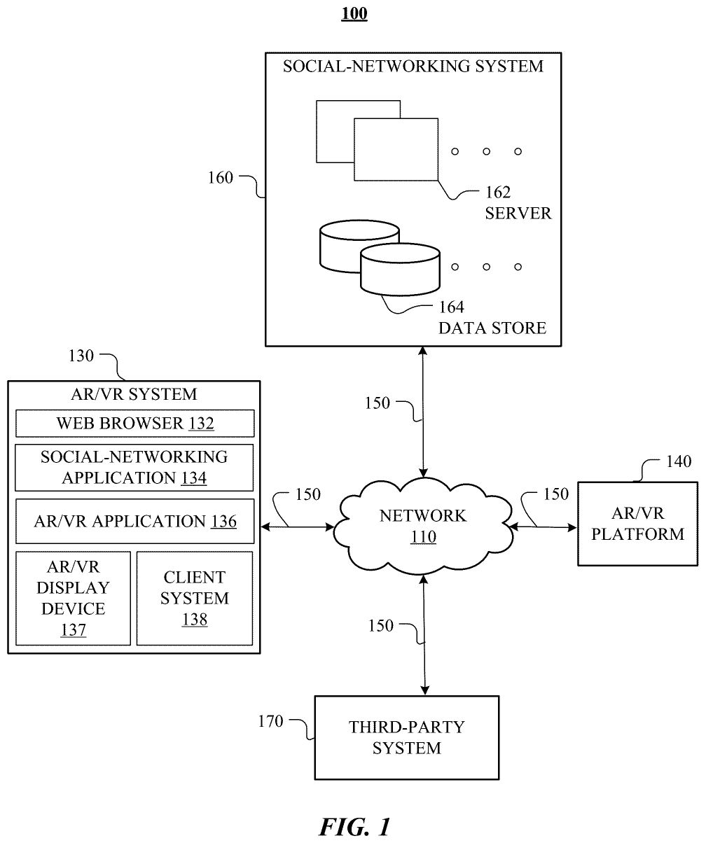

FIG. 1 illustrates an example network environment 100 associated with an augmented-reality (AR)/virtual-reality (VR) system 130. Network environment 100 includes the AR/VR system 130, an AR/VR platform 140, a social-networking system 160, and a third-party system 170 connected to each other by a network 110. Although FIG. 1 illustrates a particular arrangement of an AR/VR system 130, an AR/VR platform 140, a social-networking system 160, a third-party system 170, and a network 110, this disclosure contemplates any suitable arrangement of an AR/VR system 130, an AR/VR platform 140, a social-networking system 160, a third-party system 170, and a network 110. As an example and not by way of limitation, two or more of an AR/VR system 130, a social-networking system 160, an AR/VR platform 140, and a third-party system 170 may be connected to each other directly, bypassing a network 110. As another example, two or more of an AR/VR system 130, an AR/VR platform 140, a social-networking system 160, and a third-party system 170 may be physically or logically co-located with each other in whole or in part. Moreover, although FIG. 1 illustrates a particular number of AR/VR systems 130, AR/VR platforms 140, social-networking systems 160, third-party systems 170, and networks 110, this disclosure contemplates any suitable number of AR/VR systems 130, AR/VR platforms 140, social-networking systems 160, third-party systems 170, and networks 110. As an example and not by way of limitation, network environment 100 may include multiple AR/VR systems 130, AR/VR platforms 140, social-networking systems 160, third-party systems 170, and networks 110.

This disclosure contemplates any suitable network 110. As an example and not by way of limitation, one or more portions of a network 110 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular technology-based network, a satellite communications technology-based network, another network 110, or a combination of two or more such networks 110.

Links 150 may connect an AR/VR system 130, an AR/VR platform 140, a social-networking system 160, and a third-party system 170 to a communication network 110 or to each other. This disclosure contemplates any suitable links 150. In particular embodiments, one or more links 150 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 150 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout a network environment 100. One or more first links 150 may differ in one or more respects from one or more second links 150.

In particular embodiments, an AR/VR system 130 may be any suitable electronic device including hardware, software, or embedded logic components, or a combination of two or more such components, and may be capable of carrying out the functionalities implemented or supported by an AR/VR system 130. As an example and not by way of limitation, the AR/VR system 130 may include a computer system such as a desktop computer, notebook or laptop computer, netbook, a tablet computer, e-book reader, GPS device, camera, personal digital assistant (PDA), handheld electronic device, cellular telephone, smartphone, smart speaker, smart watch, smart glasses, augmented-reality (AR) smart glasses, virtual-reality (VR) headset, other suitable electronic device, or any suitable combination thereof. This disclosure contemplates any suitable AR/VR systems 130. In particular embodiments, an AR/VR system 130 may enable a network user at an AR/VR system 130 to access a network 110. The AR/VR system 130 may also enable the user to communicate with other users at other AR/VR systems 130.

In particular embodiments, an AR/VR system 130 may include a web browser 132, and may have one or more add-ons, plug-ins, or other extensions. A user at an AR/VR system 130 may enter a Uniform Resource Locator (URL) or other address directing a web browser 132 to a particular server (such as server 162, or a server associated with a third-party system 170), and the web browser 132 may generate a Hyper Text Transfer Protocol (HTTP) request and communicate the HTTP request to server. The server may accept the HTTP request and communicate to an AR/VR system 130 one or more Hyper Text Markup Language (HTML) files responsive to the HTTP request. The AR/VR system 130 may render a web interface (e.g. a webpage) based on the HTML files from the server for presentation to the user. This disclosure contemplates any suitable source files. As an example and not by way of limitation, a web interface may be rendered from HTML files, Extensible Hyper Text Markup Language (XHTML) files, or Extensible Markup Language (XML) files, according to particular needs. Such interfaces may also execute scripts, combinations of markup language and scripts, and the like. Herein, reference to a web interface encompasses one or more corresponding source files (which a browser may use to render the web interface) and vice versa, where appropriate.

In particular embodiments, an AR/VR system 130 may include a social-networking application 134 installed on the AR/VR system 130. A user at an AR/VR system 130 may use the social-networking application 134 to access on online social network. The user at the AR/VR system 130 may use the social-networking application 134 to communicate with the user's social connections (e.g., friends, followers, followed accounts, contacts, etc.). The user at the AR/VR system 130 may also use the social-networking application 134 to interact with a plurality of content objects (e.g., posts, news articles, ephemeral content, etc.) on the online social network. As an example and not by way of limitation, the user may browse trending topics and breaking news using the social-networking application 134.

In particular embodiments, an AR/VR system 130 may include an AR/VR application 136. As an example and not by way of limitation, an AR/VR application 136 may be able to incorporate AR/VR renderings of real-world objects from the real-world environment into an AR/VR environment. A user at an AR/VR system 130 may use the AR/VR applications 136 to interact with the AR/VR platform 140. In particular embodiments, the AR/VR application 136 may comprise a stand-alone application. In particular embodiments, the AR/VR application 136 may be integrated into the social-networking application 134 or another suitable application (e.g., a messaging application). In particular embodiments, the AR/VR application 136 may be also integrated into the AR/VR system 130, an AR/VR hardware device, or any other suitable hardware devices. In particular embodiments, the AR/VR application 136 may be also part of the AR/VR platform 140. In particular embodiments, the AR/VR application 136 may be accessed via the web browser 132. In particular embodiments, the user may interact with the AR/VR platform 140 by providing user input to the AR/VR application 136 via various modalities (e.g., audio, voice, text, vision, image, video, gesture, motion, activity, location, orientation). The AR/VR application 136 may communicate the user input to the AR/VR platform 140. Based on the user input, the AR/VR platform 140 may generate responses. The AR/VR platform 140 may send the generated responses to the AR/VR application 136. The AR/VR application 136 may then present the responses to the user at the AR/VR system 130 via various modalities (e.g., audio, text, image, video, and VR/AR rendering). As an example and not by way of limitation, the user may interact with the AR/VR platform 140 by providing a user input (e.g., a verbal request for information of an object in the AR/VR environment) via a microphone of the AR/VR system 130. The AR/VR application 136 may then communicate the user input to the AR/VR platform 140 over network 110. The AR/VR platform 140 may accordingly analyze the user input, generate a response based on the analysis of the user input, and communicate the generated response back to the AR/VR application 136. The AR/VR application 136 may then present the generated response to the user in any suitable manner (e.g., displaying a text-based push notification and/or AR/VR rendering(s) illustrating the information of the object on a display of the AR/VR system 130).

In particular embodiments, an AR/VR system 130 may include an AR/VR display device 137 and, optionally, a client system 138. The AR/VR display device 137 may be configured to render outputs generated by the AR/VR platform 140 to the user. The client system 138 may comprise a companion device. The client system 138 may be configured to perform computations associated with particular tasks (e.g., communications with the AR/VR platform 140) locally (i.e., on-device) on the client system 138 in particular circumstances (e.g., when the AR/VR display device 137 is unable to perform said computations). In particular embodiments, the AR/VR system 130, the AR/VR display device 137, and/or the client system 138 may each be a suitable electronic device including hardware, software, or embedded logic components, or a combination of two or more such components, and may be capable of carrying out, individually or cooperatively, the functionalities implemented or supported by the AR/VR system 130 described herein. As an example and not by way of limitation, the AR/VR system 130, the AR/VR display device 137, and/or the client system 138 may each include a computer system such as a desktop computer, notebook or laptop computer, netbook, a tablet computer, e-book reader, GPS device, camera, personal digital assistant (PDA), handheld electronic device, cellular telephone, smartphone, smart speaker, virtual-reality (VR) headset, augmented-reality (AR) smart glasses, other suitable electronic device, or any suitable combination thereof. In particular embodiments, the AR/VR display device 137 may comprise a VR headset and the client system 138 may comprise a smart phone. In particular embodiments, the AR/VR display device 137 may comprise AR smart glasses and the client system 138 may comprise a smart phone.

In particular embodiments, a user may interact with the AR/VR platform 140 using the AR/VR display device 137 or the client system 138, individually or in combination. In particular embodiments, an application on the AR/VR display device 137 may be configured to receive user input from the user, and a companion application on the client system 138 may be configured to handle user inputs (e.g., user requests) received by the application on the AR/VR display device 137. In particular embodiments, the AR/VR display device 137 and the client system 138 may be associated with each other (i.e., paired) via one or more wireless communication protocols (e.g., Bluetooth).

The following example workflow illustrates how an AR/VR display device 137 and a client system 138 may handle a user input provided by a user. In this example, an application on the AR/VR display device 137 may receive a user input comprising a user request directed to the VR display device 137. The application on the AR/VR display device 137 may then determine a status of a wireless connection (i.e., tethering status) between the AR/VR display device 137 and the client system 138. If a wireless connection between the AR/VR display device 137 and the client system 138 is not available, the application on the AR/VR display device 137 may communicate the user request (optionally including additional data and/or contextual information available to the AR/VR display device 137) to the AR/VR platform 140 via the network 110. The AR/VR platform 140 may then generate a response to the user request and communicate the generated response back to the AR/VR display device 137. The AR/VR display device 137 may then present the response to the user in any suitable manner. Alternatively, if a wireless connection between the AR/VR display device 137 and the client system 138 is available, the application on the AR/VR display device 137 may communicate the user request (optionally including additional data and/or contextual information available to the AR/VR display device 137) to the companion application on the client system 138 via the wireless connection. The companion application on the client system 138 may then communicate the user request (optionally including additional data and/or contextual information available to the client system 138) to the AR/VR platform 140 via the network 110. The AR/VR platform 140 may then generate a response to the user request and communicate the generated response back to the client system 138. The companion application on the client system 138 may then communicate the generated response to the application on the AR/VR display device 137. The AR/VR display device 137 may then present the response to the user in any suitable manner. In the preceding example workflow, the AR/VR display device 137 and the client system 138 may each perform one or more computations and/or processes at each respective step of the workflow. In particular embodiments, performance of the computations and/or processes disclosed herein may be adaptively switched between the AR/VR display device 137 and the client system 138 based at least in part on a device state of the AR/VR display device 137 and/or the client system 138, a task associated with the user input, and/or one or more additional factors. As an example and not by way of limitation, one factor may be signal strength of the wireless connection between the AR/VR display device 137 and the client system 138. For example, if the signal strength of the wireless connection between the AR/VR display device 137 and the client system 138 is strong, the computations and processes may be adaptively switched to be substantially performed by the client system 138 in order to, for example, benefit from the greater processing power of the CPU of the client system 138. Alternatively, if the signal strength of the wireless connection between the AR/VR display device 137 and the client system 138 is weak, the computations and processes may be adaptively switched to be substantially performed by the AR/VR display device 137 in a standalone manner. In particular embodiments, if the AR/VR system 130 does not comprise a client system 138, the aforementioned computations and processes may be performed solely by the AR/VR display device 137 in a standalone manner.

In particular embodiments, the AR/VR platform 140 may comprise a backend platform or server for the AR/VR system 130. The AR/VR platform 140 may interact with the AR/VR system 130, and/or the social-networking system 160, and/or the third-party system 170 when executing tasks.

In particular embodiments, the social-networking system 160 may be a network-addressable computing system that can host an online social network. The social-networking system 160 may generate, store, receive, and send social-networking data, such as, for example, user profile data, concept-profile data, social-graph information, or other suitable data related to the online social network. The social-networking system 160 may be accessed by the other components of network environment 100 either directly or via a network 110. As an example and not by way of limitation, an AR/VR system 130 may access the social-networking system 160 using a web browser 132 or a native application associated with the social-networking system 160 (e.g., a mobile social-networking application, a messaging application, another suitable application, or any combination thereof) either directly or via a network 110. In particular embodiments, the social-networking system 160 may include one or more servers 162. Each server 162 may be a unitary server or a distributed server spanning multiple computers or multiple datacenters. As an example and not by way of limitation, each server 162 may be a web server, a news server, a mail server, a message server, an advertising server, a file server, an application server, an exchange server, a database server, a proxy server, another server suitable for performing functions or processes described herein, or any combination thereof. In particular embodiments, each server 162 may include hardware, software, or embedded logic components or a combination of two or more such components for carrying out the appropriate functionalities implemented or supported by server 162. In particular embodiments, the social-networking system 160 may include one or more data stores 164. Data stores 164 may be used to store various types of information. In particular embodiments, the information stored in data stores 164 may be organized according to specific data structures. In particular embodiments, each data store 164 may be a relational, columnar, correlation, or other suitable database. Although this disclosure describes or illustrates particular types of databases, this disclosure contemplates any suitable types of databases. Particular embodiments may provide interfaces that enable an AR/VR system 130, a social-networking system 160, an AR/VR platform 140, or a third-party system 170 to manage, retrieve, modify, add, or delete, the information stored in data store 164.

In particular embodiments, the social-networking system 160 may store one or more social graphs in one or more data stores 164. In particular embodiments, a social graph may include multiple nodes—which may include multiple user nodes (each corresponding to a particular user) or multiple concept nodes (each corresponding to a particular concept)—and multiple edges connecting the nodes. The social-networking system 160 may provide users of the online social network the ability to communicate and interact with other users. In particular embodiments, users may join the online social network via the social-networking system 160 and then add connections (e.g., relationships) to a number of other users of the social-networking system 160 whom they want to be connected to. Herein, the term “friend” may refer to any other user of the social-networking system 160 with whom a user has formed a connection, association, or relationship via the social-networking system 160.

In particular embodiments, the social-networking system 160 may provide users with the ability to take actions on various types of items or objects, supported by the social-networking system 160. As an example and not by way of limitation, the items and objects may include groups or social networks to which users of the social-networking system 160 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in the social-networking system 160 or by an external system of a third-party system 170, which is separate from the social-networking system 160 and coupled to the social-networking system 160 via a network 110.

In particular embodiments, the social-networking system 160 may be capable of linking a variety of entities. As an example and not by way of limitation, the social-networking system 160 may enable users to interact with each other as well as receive content from third-party systems 170 or other entities, or to allow users to interact with these entities through an application programming interfaces (API) or other communication channels.

In particular embodiments, a third-party system 170 may include one or more types of servers, one or more data stores, one or more interfaces, including but not limited to APIs, one or more web services, one or more content sources, one or more networks, or any other suitable components, e.g., that servers may communicate with. A third-party system 170 may be operated by a different entity from an entity operating the social-networking system 160. As an example and not by way of limitation, the entity operating the third-party system 170 may be a developer for one or more AR/VR applications 136. In particular embodiments, however, the social-networking system 160 and third-party systems 170 may operate in conjunction with each other to provide social-networking services to users of the social-networking system 160 or third-party systems 170. In this sense, the social-networking system 160 may provide a platform, or backbone, which other systems, such as third-party systems 170, may use to provide social-networking services and functionality to users across the Internet.

In particular embodiments, a third-party system 170 may include a third-party content object provider. As an example and not by way of limitation, the third-party content object provider may be a developer for one or more AR/VR applications 136. A third-party content object provider may include one or more sources of content objects, which may be communicated to an AR/VR system 130. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects. As yet another example and not by way of limitation, content objects may include one or more AR/VR applications 136. In particular embodiments, a third-party content provider may use one or more third-party agents to provide content objects and/or services. A third-party agent may be an implementation that is hosted and executing on the third-party system 170.

In particular embodiments, the social-networking system 160 also includes user-generated content objects, which may enhance a user's interactions with the social-networking system 160. User-generated content may include anything a user can add, upload, send, or “post” to the social-networking system 160. As an example and not by way of limitation, a user communicates posts to the social-networking system 160 from an AR/VR system 130. Posts may include data such as status updates or other textual data, location information, photos, videos, links, music or other similar data or media. Content may also be added to the social-networking system 160 by a third-party through a “communication channel,” such as a newsfeed or stream.

In particular embodiments, the social-networking system 160 may include a variety of servers, sub-systems, programs, modules, logs, and data stores. In particular embodiments, the social-networking system 160 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. The social-networking system 160 may also include suitable components such as network interfaces, security mechanisms, load balancers, failover servers, management-and-network-operations consoles, other suitable components, or any suitable combination thereof. In particular embodiments, the social-networking system 160 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking the social-networking system 160 to one or more AR/VR systems 130 or one or more third-party systems 170 via a network 110. The web server may include a mail server or other messaging functionality for receiving and routing messages between the social-networking system 160 and one or more AR/VR systems 130. An API-request server may allow, for example, an AR/VR platform 140 or a third-party system 170 to access information from the social-networking system 160 by calling one or more APIs. An action logger may be used to receive communications from a web server about a user's actions on or off the social-networking system 160. In conjunction with the action log, a third-party-content-object log may be maintained of user exposures to third-party-content objects. A notification controller may provide information regarding content objects to an AR/VR system 130. Information may be pushed to an AR/VR system 130 as notifications, or information may be pulled from an AR/VR system 130 responsive to a user input comprising a user request received from an AR/VR system 130. Authorization servers may be used to enforce one or more privacy settings of the users of the social-networking system 160. A privacy setting of a user may determine how particular information associated with a user can be shared. The authorization server may allow users to opt in to or opt out of having their actions logged by the social-networking system 160 or shared with other systems (e.g., a third-party system 170), such as, for example, by setting appropriate privacy settings. Third-party-content-object stores may be used to store content objects received from third parties, such as a third-party system 170. Location stores may be used for storing location information received from AR/VR systems 130 associated with users. Advertisement-pricing modules may combine social information, the current time, location information, or other suitable information to provide relevant advertisements, in the form of notifications, to a user.

### Augmented-Reality Systems

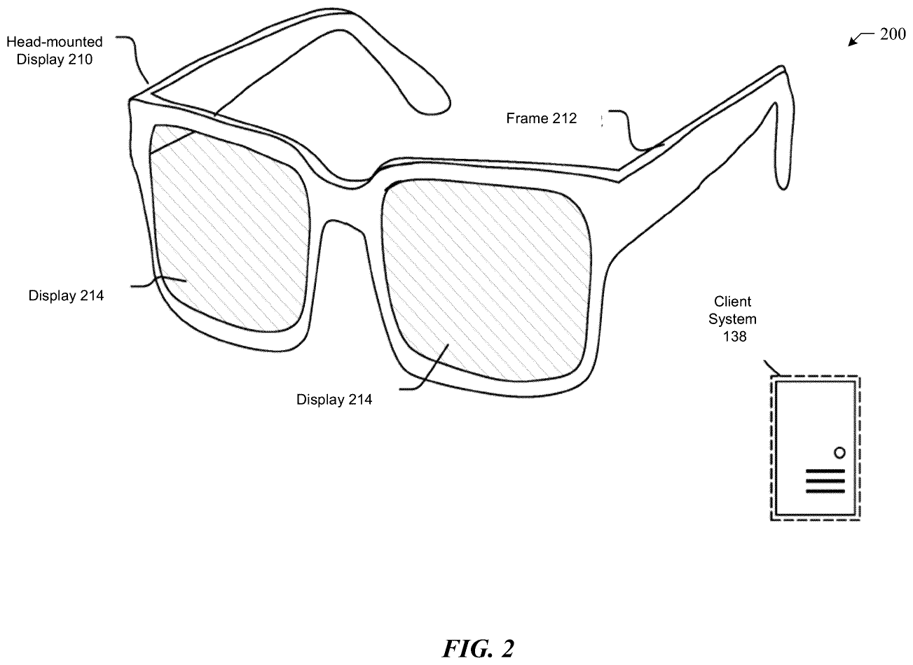

FIG. 2 illustrates an example augmented-reality system 200. In particular embodiments, the augmented-reality system 200 can perform one or more processes as described herein. The augmented-reality system 200 may include a head-mounted display (HMD) 210 (e.g., glasses) comprising a frame 212, one or more displays 214, and a client system 138. The displays 214 may be transparent or translucent allowing a user wearing the HMD 210 to look through the displays 214 to see the real world and displaying visual artificial reality content to the user at the same time. The HMD 210 may include an audio device that may provide audio artificial reality content to users. The HMD 210 may include one or more cameras which can capture images and videos of environments. The HMD 210 may include an eye tracking system to track the vergence movement of the user wearing the HMD 210. The HMD 210 may include a microphone to capture voice input from the user. The augmented-reality system 200 may further include a controller comprising a trackpad and one or more buttons. The controller may receive inputs from users and relay the inputs to the client system 138. The controller may also provide haptic feedback to users. The client system 138 may be connected to the HMD 210 and the controller through cables or wireless connections. The client system 138 may control the HMD 210 and the controller to provide the augmented-reality content to and receive inputs from users. The client system 138 may be a standalone host computer device, an on-board computer device integrated with the HMD 210, a mobile device, or any other hardware platform capable of providing augmented-reality content to and receiving inputs from users.

Object tracking within the image domain is a known technique. For example, a stationary camera may capture a video of a moving object, and a computing system may compute, for each frame, the 3D position of an object of interest or one of its observable features relative to the camera. When the camera is stationary, any change in the object's position is attributable only to the object's movement and/or jitter caused by the tracking algorithm. In this case, the motion of the tracked object could be temporally smoothed by simply applying a suitable averaging algorithm (e.g., averaging with an exponential temporal decay) to the current estimated position of the object and the previously estimated position(s) of the object.

Motion smoothing becomes much more complex in the context of augmented reality. For augmented-reality systems, an external-facing camera is often mounted on the HMD and, therefore, could be capturing a video of another moving object while moving with the user's head. When using such a non-stationary camera to track a moving object, the tracked positional changes of the object could be due to not only the object's movements but also the camera's movements. Therefore, the aforementioned method for temporally smoothing the tracked positions of the object would no longer work.

### Virtual-Reality Systems

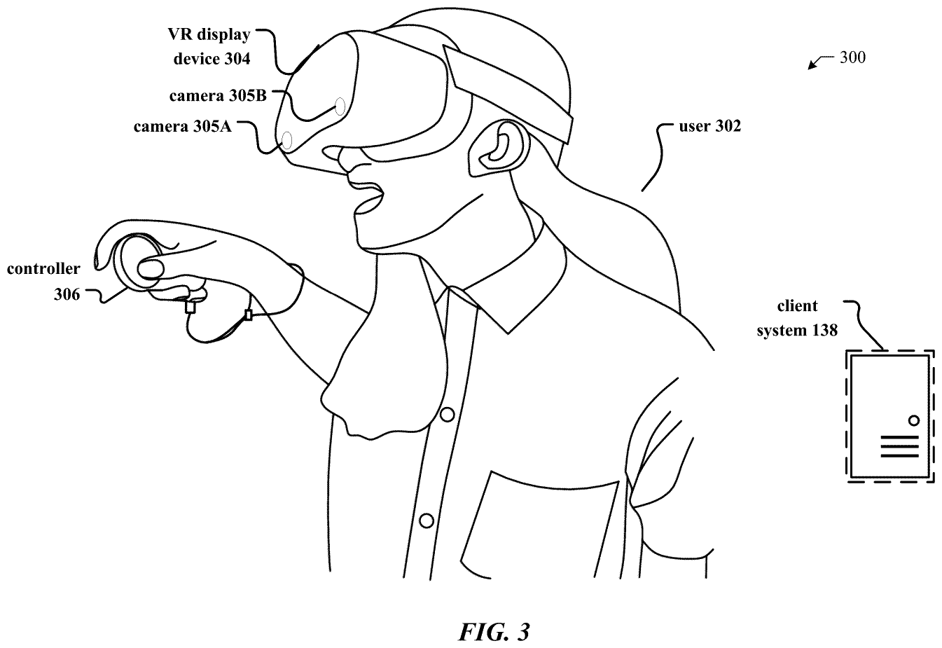

FIG. 3 illustrates an example of a virtual reality (VR) system 300 worn by a user 302. In particular embodiments, the VR system 300 may comprise a head-mounted VR display device 304, a controller 306, and one or more client systems 138. The VR display device 304 may be worn over the user's eyes and provide visual content to the user 302 through internal displays (not shown). The VR display device 304 may have two separate internal displays, one for each eye of the user 302 (single display devices are also possible). In particular embodiments, the VR display device 304 may comprise one or more external-facing cameras, such as the two forward-facing cameras 305A and 305B, which can capture images and videos of the real-world environment. The VR system 300 may further include one or more client systems 138. The one or more client systems 138 may be a stand-alone unit that is physically separate from the VR display device 304 or the client systems 138 may be integrated with the VR display device 304. In embodiments where the one or more client systems 138 are a separate unit, the one or more client systems 138 may be communicatively coupled to the VR display device 304 via a wireless or wired link. The one or more client systems 138 may be a high-performance device, such as a desktop or laptop, or a resource-limited device, such as a mobile phone. A high-performance device may have a dedicated GPU and a high-capacity or constant power source. A resource-limited device, on the other hand, may not have a GPU and may have limited battery capacity. As such, the algorithms that could be practically used by a VR system 300 depends on the capabilities of its one or more client systems 138.

### User Interface

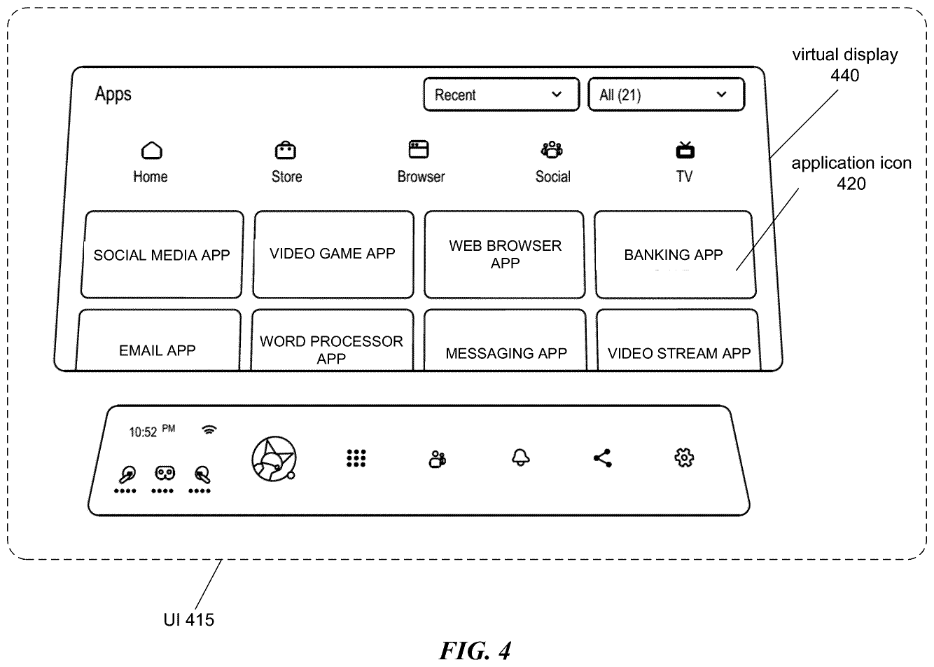

FIG. 4 illustrates an example UI 415. The UI 415 may appear as a menu or dashboard for the user to execute one or more tasks, e.g., the user may use the UI 415 to execute one or more applications (from among the plurality of applications selectable by application icons 420), such as gaming applications, work applications, entertainment applications, call/chat applications, etc. The UI 415 may be a feature of the VR operating system (VROS) associated with the virtual reality system 400. The plurality of applications may correspond to applications accessible on a real-world computing device associated with the user, such as the user's smartphone, tablet, laptop computer, or other computing device. The VROS may have various built-in functionalities. As an example and not by way of limitation, the UI 415 of the VROS may provide access to a built-in web browser application and social media application that the user can access. If the user is in a virtual meeting, the user may quickly research a topic on the web browser on the UI 415 without having to exit the virtual meeting. If the user is playing a VR video game on a video game application and wants to post their high score, the user may access their social media application from their UI 415 and post their high score directly onto their social media, without having to leave the video game application.

### Content-Concealing Visual Descriptors Via Adversarial Learning

In particular embodiments, one or more computing systems may modify an image-descriptor network to generate descriptor vectors that may not be inverted to reconstruct images corresponding to these descriptor vectors to protect privacy. Computer vision applications may use high-dimensional feature vectors to represent images and portions thereof. However, these vectors may be used in reverse to reconstruct the images, e.g., by inputting the descriptor vectors into an inversion network, which outputs an estimated image. The possibility of high-quality image reconstruction based on descriptor vectors may be problematic for privacy reasons, especially when the feature vectors are provided to downstream third-party processes. To address the issue, this application developed a novel encoder, which may take the base descriptor vectors (e.g., SIFT) and encode them in a way to minimize the utility loss and maximize the reconstruction loss, thereby generating descriptor vectors that can't be inverted. These descriptor vectors may still contain enough information to be useful for downstream processes, but when inverted, they may generate low-quality estimated images. The encoder may be trained using a joint adversarial training model. The adversarial training model may be set to minimize the utility loss and maximize the reconstruction loss. In other words, the encoder may be optimized to maximize the utility of the descriptor vectors for downstream processing while minimizing the ability of an inversion network to accurately reconstruct the original image. Although this disclosure describes encoding particular descriptors by particular systems in a particular manner, this disclosure contemplates encoding any suitable descriptor by any suitable system in any suitable manner.

Introduction

In the light of recent analyses on privacy-concerning scene revelation from visual descriptors, the embodiments disclosed herein develop descriptors that conceal the input image content. In particular, the embodiments disclosed herein disclose an adversarial learning framework for training visual descriptors that prevent image reconstruction, while maintaining the matching accuracy. We may let a feature encoding network and image reconstruction network compete with each other, such that the feature encoder tries to impede the image reconstruction with its generated descriptors, while the reconstructor tries to recover the input image from the descriptors. The experimental results demonstrate that the visual descriptors obtained with our method significantly deteriorate the image reconstruction quality with minimal impact on correspondence matching and camera localization performance.

Local visual descriptors [7,13,56,73,75] may be fundamental to a wide range of computer vision applications such as SLAM [15, 40, 42, 45], SfM [1, 65, 72], wide-baseline stereo [30,43], calibration [49], tracking [24,44,51], image retrieval [3, 4, 32, 46, 47, 67, 78, 79], and camera pose estimation [5,17,54,61,62,76,77]. These descriptors may represent local regions of images and be used to establish local correspondences between and across images and 3D models.

The descriptors may take the form of vectors in high-dimensional space, and thus may be not directly interpretable by humans. However, researchers have shown that it is possible to reveal the input images from local visual descriptors [10, 16,81]. With the recent advances in deep learning, the quality of the reconstructed image content has been significantly improved [11, 53]. This pose potential privacy concerns for visual descriptors if they are used for sensitive data without proper encryption [11,70,81].

To prevent the reconstruction of the image content from visual descriptors, several methods have been proposed. These methods include obfuscating key-point locations by lifting them to lines that pass through the original points [21, 66,70,71], or to affine subspaces with augmented adversarial feature samples [18] to increase the difficulty of recovering the original images. However, recent work [9] has demonstrated that the closest points between lines can yield a good approximation to the original points locations. The embodiments disclosed herein explore whether such local feature inversion could be mitigated at the descriptor level. Ideally, we may want a descriptor that does not reveal the image content without a compromise in its performance. This may seem counter-intuitive due to the trade-off between utility and privacy discussed in the recent analysis on visual descriptors [11], where the utility is defined as matching accuracy, and the privacy is defined as non-invertibility of the descriptors. The analysis showed that the more useful the descriptors are for correspondence matching, the easier it is to invert them. To minimize this trade-off, we propose an adversarial approach to train visual descriptors.

Specifically, we may optimize our descriptor encoding network with an adversarial loss for descriptor invertibility, in addition to the traditional metric learning loss for feature correspondence matching. For the adversarial loss, we may jointly train an image reconstruction network to compete with the descriptor network in revealing the original image content from the descriptors. In this way, the descriptor network may learn to hinder the reconstruction network by generating visual descriptors that conceal the image content, while being optimized for correspondence matching.

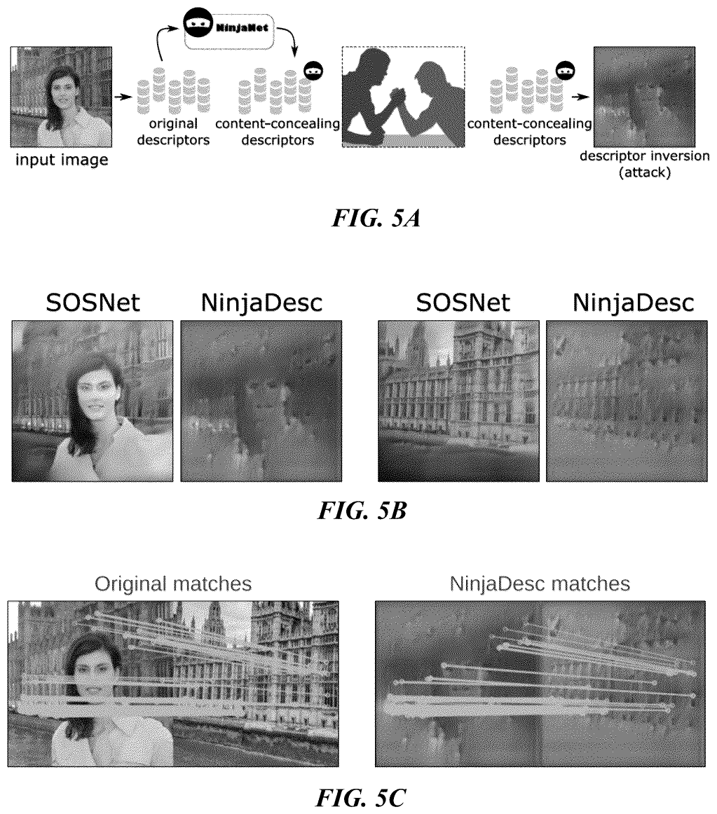

In particular, we introduce an auxiliary encoder network NinjaNet that may be trained with any existing visual descriptors and transform them to our content-concealing NinjaDesc. FIG. 5A illustrates an example process for processing an input image with our content-concealing visual descriptor. We train NinjaNet, the content-concealing network via adversarial learning to give NinjaDesc. FIG. 5B illustrates example comparisons of inversions. On the two examples shown, we compare inversions on SOSNet [75] descriptors versus NinjaDesc (encoding SOSNet with NinjaNet). FIG. 5C illustrates an example comparison of matches. NinjaDesc may be able to conceal facial features and landmark structures, while retaining correspondences. In the experiments, we show that visual descriptors trained with our adversarial learning framework lead to only marginal drop in performance for feature matching and visual localization tasks, while significantly reducing the visual similarity of the reconstruction to the original input image.

One of the main benefits of our method may be that we can control the trade-off between utility and privacy by changing a single parameter in the loss function. In addition, our method may generalize to different types of visual descriptors, and different image reconstruction network architectures.

In summary, our main innovations may be as follows: a) We propose a novel adversarial learning framework for visual descriptors to prevent reconstructing original input image content from the descriptors. We experimentally validate that the obtained descriptors significantly deteriorate the image quality from descriptor inversion with only marginal drop in matching accuracy using standard benchmarks for matching (HPatches [6]) and visual localization (Aachen Day-Night [63,85]). b) We empirically demonstrate that we can effectively control the trade-off between utility (matching accuracy) and privacy (non-invertibility) by changing a single training parameter. c) We provide ablation studies by using different types of visual descriptors, image reconstruction network architectures and scene categories to demonstrate the generalizability of our method.

Related Work

This section discusses prior work on visual descriptor inversion and the state-of-the-art descriptor designs that attempt to prevent such inversion.

Inversion of visual descriptors. Early results of reconstructing images from local descriptors was shown by Weinzaepfel et al. [81] by stitching the image patches from a known database with the closest distance to the input SIFT [37] descriptors in the feature space. d'Angelo et al. [10] used a deconvolution approach on local binary descriptors such as BRIEF [8] and FREAK [2]. Vondrick et al. [80] used paired dictionary learning to invert HoG [86] features to reveal its limitations for object detection. For global descriptors, Kato and Harada [31] reconstructed images from Bag-of-Words descriptors [69]. However, the quality of reconstructions by these early works were not sufficient to raise concerns about privacy or security.

Subsequent work introduced methods that steadily improved the quality of the reconstructions. Mahendran and Vedaldi [39] used a back-propagation technique with a natural image prior to invert CNN features as well as SIFT [36] and HOG [86]. Dosovitskiy and Brox [16] trained up-convolutional networks that estimate the input image from features in a regression fashion, and demonstrated superior results on both classical [37, 48, 86] and CNN [34] features. In the recent work, descriptor inversion methods have started to leverage larger and more advanced CNN models as well as employ advanced optimization techniques. Pittaluga et al. [53] and Dangwal et al. [11] demonstrated sufficiently high reconstruction qualities, revealing not only semantic information but also details in the original images.

Preventing descriptor inversion for privacy. Descriptor inversion raises privacy concerns [11,53,70,81]. For example, in computer vision systems where the visual descriptors are transferred between the device and the server, an honest-but-curious server may exploit the descriptors sent by the client device. In particular, many large-scale localization systems adopt cloud computing and storage, due to limited compute on mobile devices. Homomorphic encryption [19,60,84] can protect descriptors, but are too computationally expensive for large-scale applications.

Proposed by Speciale et al. [70], the line-cloud representation obfuscate 2D/3D point locations in the map building process [20, 21, 66] without compromising the accuracy in localization. However, since the descriptors are unchanged, Chelani et al. [9] showed that line-clouds are vulnerable to inversion attacks if the underlying point-cloud is recovered.

Adversarial learning has been applied in image encoding [27, 52, 82] that optimizes privacy-utility trade-off, but not in the context of local descriptor inversions, which involves reconstruction of images from dense inputs and has a much broader scope of downstream applications.

Recently, Dusmanu et al. [18] proposed a privacy-preserving visual descriptor via lifting descriptors to affine subspaces, which conceals the visual content from inversion attacks. However, this comes with a significant cost on the descriptor's utility in downstream tasks. Our work differs from [18] in that we propose a learned content-concealing descriptor and explicitly train it for utility retention to achieve a better trade-off between the two.

Method

We propose an adversarial learning framework for obtaining content-concealing visual descriptors, by introducing a descriptor inversion model as an adversary. In this section, we detail our content-concealing encoder NinjaNet and the descriptor inversion model, as well as the joint adversarial training procedure.

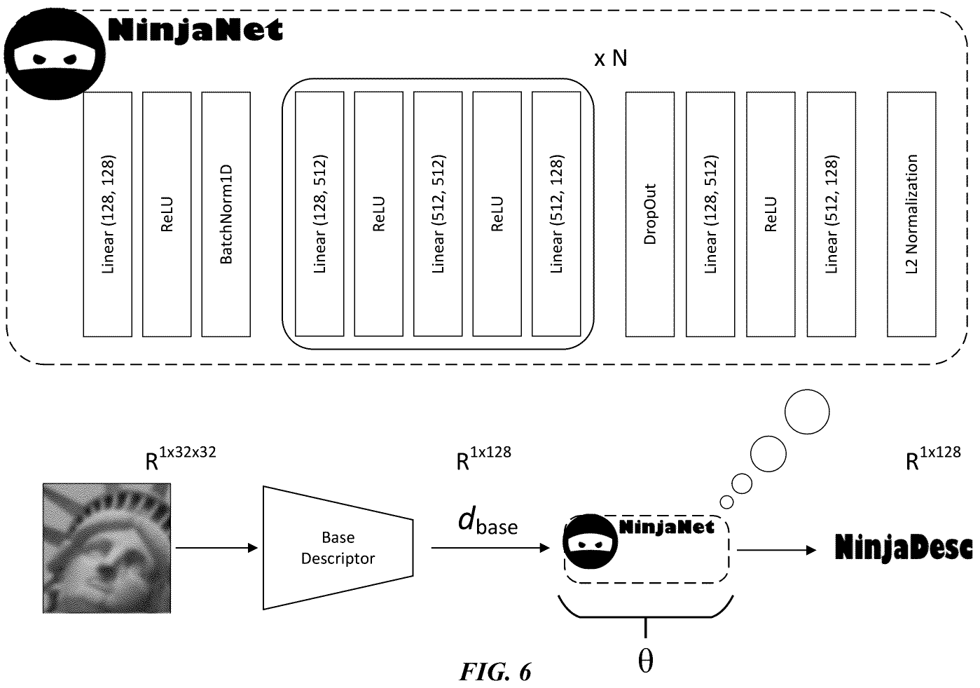

FIG. 6 illustrates an example architecture of our content-concealing NinjaNet encoder and an example transformation of a base descriptor. The base description with dimensionality C may be transformed to NinjaDesc of the same size, e.g., C=128. In order to conceal the visual content of a local descriptor while maintaining its utility, we may need a trainable encoder which transforms the original descriptor space to a different one, where visual information essential for reconstruction is reduced. Our NinjaNet encoder Θ may be implemented by an MLP shown in FIG. 6. It may take a base descriptor d_{base}, and transform it into a content-concealing NinjaDesc, dₙᵢₙⱼₐ:

dₙᵢₙⱼₐ=θ(d_{base}). (1)

The design of NinjaNet may be light-weight and plug-and-play, to make it flexible in accepting different types of existing local descriptors. The encoded NinjaDesc descriptor may maintain the matching performance of the original descriptor, but prevent from high-quality reconstruction of images. In many of our experiments, we adopt SOSNet [75] as our base descriptor since it may be one of the top-performing descriptors for correspondence matching and visual localization [30].

Utility initialization. To maintain the utility (i.e., accuracy for downstream tasks) of our encoded descriptor, we may use a patch-based descriptor training approach [41, 74, 75]. The initialization step may train NinjaNet via a triplet-based ranking loss. We mayuse the UBC dataset [22] which contains three subsets of patches labelled as positive and negative pairs, allowing for easy implementation of triplet-loss training.

Utility loss. We may extract the base descriptors d_{base} from image patches X_{patch} and train NinjaNet (Θ) with the descriptor learning loss from [75] to optimize NinjaDesc (dₙᵢₙⱼₐ):

Lᵤₜᵢₗ(X_{patch};θ)=Lₜᵣᵢₚₗₑₜ(dₙᵢₙⱼₐ)L_{reg}.(dₙᵢₙⱼₐ), (2)

where Lreg. (·) is the second-order similarity regularization term [75]. We may always freeze the weights of the base descriptor network, including the joint training process.

For our proposed adversarial learning framework, we may utilize a descriptor inversion network as the adversary to reconstruct the input images from our NinjaDesc. We may adopt the UNet-based [58] inversion network from prior work [11, 53]. Following Dangwal et al. [11], the inversion model may take as input the sparse feature map FΘ∈RH×W×C composed from the descriptors and their key-points, and predict the RGB image I\hat{ }∈Rh×w×3, i.e. I\hat{ }=(FΘ). We denote (H, W), (h, w) as the resolutions of the sparse feature image and the reconstructed RGB image, respectively. C is the dimensionality of the descriptor. The detailed architecture is provided in the supplementary.

Reconstruction loss. The descriptor inversion model may be optimized under a reconstruction loss which is composed of two parts. The first loss may be the mean absolute error (MAE) between the predicted I and input I images,

Lₘₐₑ=Σᵢ^{h}Σⱼ^{w}∥Î_{i,j}−Î_{i,j}∥₁. (3)

The second loss may be the perceptual loss, which is the L2 distance between intermediate features of a VGG16 [68] network pretrained on ImageNet [12],

Lₘₐₑ=Σₖ₋₁³Σᵢ^{h}^{ₖ}Σⱼ^{w}^{ₖ}∥ψ_{k,i,j}^{vGG}(Î)−ψ_{k,i,j}^{vGG}(I)∥₂², (4)

where _{Ψ}V GG k (I) are the feature maps extracted at layers k∈{2, 9, 16}, and (hk, wk) is the corresponding resolution.

The reconstruction loss may be the sum of the two terms

L_{recon}(X_{image};Φ)=Lₘₐₑ+L_{perc}, (5)

where X_{image} denote the image data term that includes both the descriptor feature map FΘ and the RGB image I.

Reconstruction initialization. For the joint adversarial training, we may initialize the inversion model using the initialized NinjaDesc. This part may be done using the MegaDepth [35] dataset, which contains images of landmarks across the world. For the key-point detection we use the Harris corners [25] in our experiments.

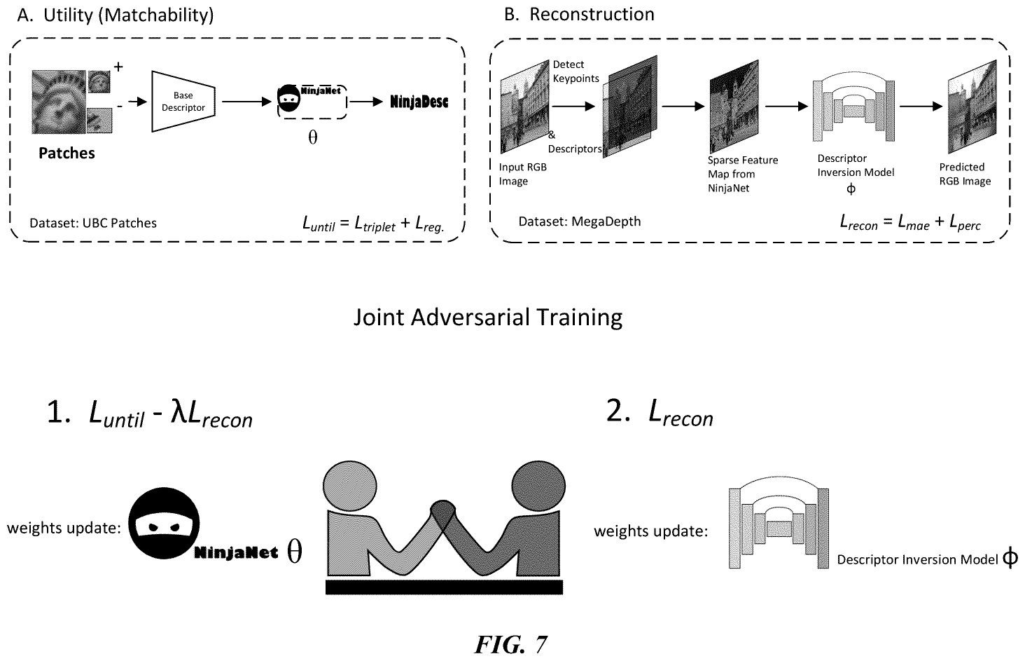

FIG. 7 illustrates an example pipeline for training our content-concealing NinjaDesc. The central component of engineering our content-concealing NinjaDesc may be the joint adversarial training step, which is illustrated in FIG. 7 and elaborated as pseudo-code in Algorithm 1. The top of FIG. 7 illustrates the two networks at play and their corresponding objectives, which are: 1. NinjaNet Q, which is for utility retention in A; and 2. the descriptor inversion model, which reconstructs RGB images from input sparse features in B. The bottom of FIG. 7 illustrates that during joint adversarial training, we may alternate between steps 1. and 2., which is presented by Algorithm 1. We aim to minimize trade-off between utility and privacy, which are the two competing objectives. Inspired by methods using adversarial learning [23,59,83], we may formulate the optimization of utility and privacy tradeoff as an adversarial learning process. The objective of the descriptor inversion model is to minimize the reconstruction error over image data X_{image}. On the other hand, NinajaNet Θ aims to conceal the visual content by maximizing this error. Thus, the resulting objective function for content concealment V (Θ,) is a minimax game between the two:

$$\frac{min}{ϕ} \frac{max}{Θ} V ( Θ , Φ ) = {L}_{recon} ( {X}_{image} ; Θ , Φ ) . \qquad ( 6 )$$

At the same time, we wish to maintain the descriptor utility:

$$\frac{min}{Θ} {L}_{util} ( {X}_{patch} ; Θ ) . \qquad ( 7 )$$

Algorithm 1 Pseudo-code for the joint adversarial
training process of NinjaDesc

```
NinjaNet: Θ 0 ← initialize with Eqn. 2
Desc. inversion model: 0 ← initialize with Eqn. 5
λ ← set privacy parameter
for i ← 1, number of iterations do
if i = 0 then
Θ ← Θ 0, Φ ← Φ0
end if
ComputeLutil^{from} Xpatch and Θ.
Extract sparse features on Ximage with Θ,
  reconstruct image with Φ
  and compute Lrecon (Ximage; Θ, ).
Update weights of Θ:
      Θ′ ← ∇_{Θ}(Lᵤₜᵢₗ − λL_{recon}).
5: Extract sparse features on Ximage with Θ’,
    reconstruct image with Φ
    and compute Lrecon(Ximage; Θ’, ).
Update weights of :
        Φ′ ← ∇_{Θ}Lᵤₜᵢₗ.
Θ ← Θ’, Φ ← Φ’
end for
```

This may bring us to the two separate optimization objectives for Θ and that we will describe in the following. For the inversion model, the objective may remain the same as in Eqn. 6:

L_{Φ}=(L_{recon}(X_{image};Θ,Φ). (8)

However, for maintaining utility, NinjaNet with weights Θ may be also optimized with the utility loss Lutil(Xpatch; Θ) from Eqn. 2. In conjunction with the maximization by Θ from Eqn. 6, the loss for NinjaNet may become

L_{Θ}=Lᵤₜᵢₗ(X_{patch};Θ)−λL_{recon}(X_{image};Θ,Φ), (9)

where λ controls the balance of how much Θ prioritizes content concealment over utility retention, i.e., the privacy parameter. In practice, we may optimize Θ in an alternating manner, such that Θ is not optimized in Eqn. 8 and is not optimized in Eqn. 9. The overall objective may be then

$${Θ}^{*} , {Φ}^{*} = \frac{arg}{Θ} \frac{min}{Φ} ( {L}_{Θ} + {L}_{Φ} ) . \qquad ( 10 )$$

The code may be implemented using PyTorch [50]. We may use Kornia [57]'s implementation of SIFT for GPU acceleration. For all training, we may use the Adam [33] optimizer with (β1, β2)=(0.9, 0.999) and λ=0.

Utility initialization. We may use the liberty set of the UBC patches [22] to train NinjaNet for 200 epochs and select the model with the lowest average FPR@95 in the other two sets (notredame and yosemite). The number of submodules in NinjaNet (N in FIG. 6) is N=1, since we observed no improvement in FPR@95 by increasing N. Dropout rate is 0.1. We use a batch-size of 1024 and learning rate of 0.01.

Reconstruction initialization. We may randomly split MegaDepth [35] into train/validation/test split of ratio 0.6/0.1/0.3. The process of forming a feature map may be the same as in [11] and we may use up to 1000 Harris corners [25] for all experiments. We may train the inversion model with a batch-size of 64, learning rate of 1e-4 for a maximum of 200 epochs and select the best model with the lowest structural similarity (SSIM) on the validation split. We may also not use the discriminator as in [11], since convergence of the discriminator may take substantially longer, and it may improve the inversion model only very slightly.

Joint adversarial training. The dataset configurations for Lutil ^{and} Lrecon may be the same as in the above two steps, except the batch size, that is 968 for UBC patches. We may use equal learning rate for Θ and Φ. This is 5e-5 for SOS-Net [75] and HardNet [41], and 1e-5 for SIFT [37]. NinjaDesc with the best FPR@95 in 20 epochs on the validation set may be selected for testing.

Experimental Results

In this section, we evaluate NinjaDesc on the two criteria that guide its design—the ability to simultaneously achieve: (1) content concealment (privacy) and (2) utility (matching accuracy and camera localization performance).

We assess the content-concealing ability of NinjaDesc by measuring the reconstruction quality of descriptor inversion attacks. Here we assume the inversion model has access to the NinjaDesc and the input RGB images for training, i.e., X_{image}. We train the inversion model from scratch for NinjaDesc (Eqn. 5) on the train split of MegaDepth [35], and the best model with the highest SSIM on the validation split is used for the evaluation.

Recall in Eqn. 9, λ is the privacy parameter controlling how much NinjaDesc prioritizes privacy over utility. The intuition may be that, the higher λ is, the more aggressive NinjaDesc tries to prevent reconstruction quality by the inversion model. We perform descriptor inversion on NinjaDesc that are trained with a range of λ values to demonstrate its effect on reconstruction quality.

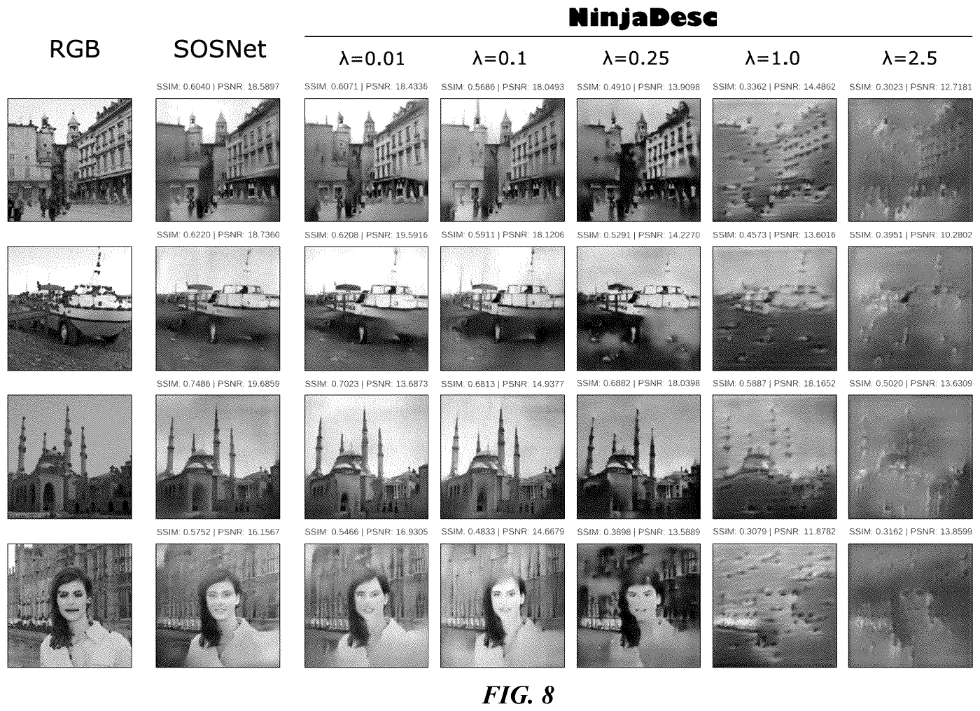

FIG. 8 illustrates example qualitative results on landmark images. First column shows original images overlaid with the 1000 Harris corners [25]. Second column shows reconstructions by the inversion model from raw SOSNet [75] descriptors extracted on those points. The last five columns show reconstruction from NinjaDesc with increasing privacy parameter λ. The SSIM and PSNR with respect to the original images are shown on top of each reconstruction. We observe that λ indeed fulfills the role of controlling how much NinjaDesc conceals the original image content. When λ is small, e.g., 0.01, 0.1, the reconstruction is only slightly worse than that from the baseline SOSNet. As λ increases to 0.25, there is a visible deterioration in quality. Once equal/stronger weighting is given to privacy (λ=1, 2.5), little texture/structure is revealed, achieving high privacy.

TABLE 2
Quantitative results of the descriptor inversion on SOSNet
vs. NinjaDesc, evaluated on the MegaDepth [35] test
split. The arrows indicate higher/lower value is better for privacy.

| | SOSNet | NinjaDesc (λ) | | | | | |
|---|---|---|---|---|---|---|---|
| Metric | (Raw) | 0.001 | 0.01 | 0.1 | 0.25 | 1.0 | 2.5 |
| MAE (↑) | 0.104 | 0.117 | 0.125 | 0.129 | 0.162 | 0.183 | 0.212 |
| SSIM (↓) | 0.596 | 0.566 | 0.569 | 0.527 | 0.484 | 0.385 | 0.349 |
| PSNR (↓) | 17.904 | 18.037 | 16.826 | 17.821 | 17.671 | 13.367 | 12.010 |

Such observation is also validated quantitatively by Table 2, where we see a drop in performance of the inversion model as λ increases across the three metrics: maximum average error (MAE), structural similarity (SSIM), and peak signal-to-noise ratio (PSNR) which are computed from the reconstructed image and the original input image. Note that in [11], only SSIM is reported, and we do not share the same train/validation/test split. Also, [11] uses the discriminator loss for training which we omit, and it leads to slight difference in SSIM.

We measure the utility of NinjaDesc via two tasks: image matching and visual localization.

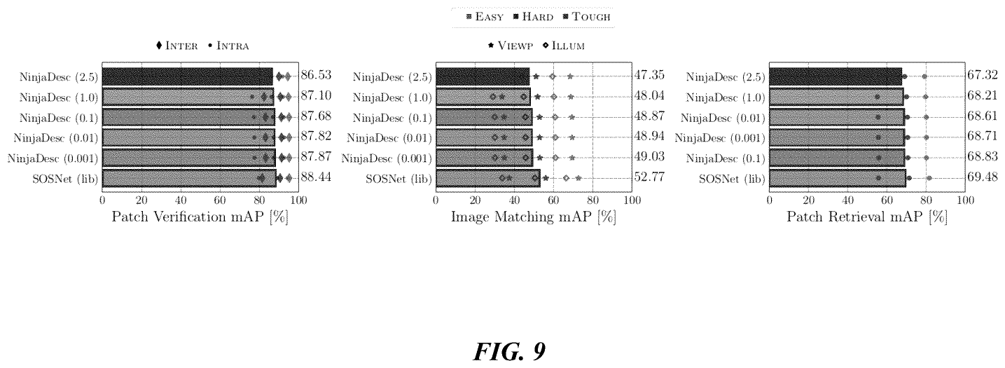

Image matching. FIG. 9 illustrates example HPatches evaluation results. We evaluate NinjaDesc based on SOSNet [75] with a set of different privacy parameter on the HPatches [6] benchmarks, which is shown in FIG. 9. There are five different levels of privacy parameter λ (indicated by the number in parenthesis). All results are from models trained on the liberty subset of the UBC patches [22] dataset. NinjaDesc is comparable with SOSNet in mAP across all three tasks, especially for the verification and retrieval tasks. Also, higher privacy parameter λ generally corresponds to lower mAP, as Lutil becomes less dominant in Eqn. 9.

TABLE 3
Visual localization results on Aachen-Day-Night v1.1 [85].
‘Raw’ corresponds to the base descriptor in each column,
followed by three λ vales (0.1, 1.0, 2.5) for NinjaDesc.

| | | | Accuracy @ Thresholds (%) | | |
|---|---|---|---|---|---|
| | | Method | 0.25 m, ₂° | 0.5 m, ₅° | 5.0 m, 10° |
| Query | NNs | Base Desc | SOS/Hard/SIFT | SOS/Hard/SIFT | SOS/Hard/SIFT |
| Day | 20 | Raw | 85.1/85.4/84.3 | 92.7/93.1/92.7 | 97.3/98.2/97.6 |
| (824) | | λ = 0.1 | 85.4/84.7/82.0 | 92.5/91.9/91.1 | 97.5/96.8/96.4 |
| | | λ = 1.0 | 84.7/84.3/82.9 | 92.4/91.9/91.0 | 97.2/96.7/96.1 |
| | | λ = 2.5 | 84.6/83.7/82.5 | 92.4/92.0/91.0 | 97.1/96.8/96.0 |
| | 50 | Raw | 85.9/86.8/86.0 | 92.5/93.7/94.1 | 97.3/98.1/98.2 |
| | | λ = 0.1 | 85.2/85.2/84.2 | 92.2/92.4/91.4 | 97.1/97.1/96.6 |
| | | λ = 1.0 | 84.7/85.7/83.4 | 92.2/92.6/91.6 | 97.2/96.7/96.7 |
| | | λ = 2.5 | 85.6/85.3/83.6 | 92.7/91.7/91.1 | 97.3/96.8/96.2 |
| Night | 20 | Raw | 49.2/52.4/50.8 | 60.2/62.3/62.3 | 68.1/72.3/72.8 |
| (191) | | λ = 0.1 | 47.6/43.5/44.0 | 57.1/54.5/51.3 | 63.4/61.8/61.3 |
| | | λ = 1.0 | 45.5/44.5/41.4 | 56.0/51.8/52.9 | 61.8/60.2/62.3 |
| | | λ = 2.5 | 45.0/44.5/43.5 | 55.0/54.5/49.7 | 61.8/61.3/61.3 |
| | 50 | Raw | 44.5/47.6/51.3 | 52.4/59.7/62.3 | 60.2/64.9/74.3 |
| | | λ = 0.1 | 39.8/39.8/41.9 | 47.6/48.7/50.3 | 57.6/56.0/59.7 |
| | | λ = 1.0 | 42.9/39.8/39.8 | 52.4/49.2/48.2 | 57.1/54.5/56.5 |
| | | λ = 2.5 | 41.9/38.2/40.3 | 49.2/47.1/49.2 | 56.6/55.0/57.1 |

Visual localization. We evaluate NinjaDesc with three base descriptors—SOSNet [75], HardNet [41] and SIFT [37] on the Aachen-Day-Night v1.1 [63,85] dataset using the Kapture [28] pipeline. We use AP-Gem [55] for retrieval and localize with the shortlist size of 20 and 50. The keypoint detector used is DoG [37]. Table 3 shows localization results. Again, we observe little drop in accuracy for NinjaDesc overall compared to the original base descriptors, ranging from low (λ=0.1) to high (λ=2.5) privacies.

Comparing our results on HardNet and SIFT with Table 4 in Dusmanu et al. [18], NinjaDesc is noticeably better in retaining the visual localization accuracy of the base descriptors than the subspace descriptors in [18], e.g., drop in night is up to 30% for HardNet in [18] but 10% for NinjaDesc. Note [18] is evaluated on Aachen-Day-Night v1.0, resulting in higher accuracy in Night due to poor ground-truths, and the code of [18] is not released yet. We also report our results on v1.0 in the supplementary.

TABLE 4
Qualitative performance of the descriptor inversion model on
the MegaDepth [35] test split with three base descriptors
and the corresponding NinjaDescs, varying in privacy parameter.

| | SSIM (↓) | | | | | |
|---|---|---|---|---|---|---|
| Base | Raw (w/o | NinjaDesc (λ) | | | | |
| Descriptor | NinjaDesc) | 0.01 | 0.1 | 0.25 | 1.0 | 2.5 |
| SOSNet | 0.596 | 0.569 | 0.527 | 0.484 | 0.385 | 0.349 |
| HardNet | 0.582 | 0.545 | 0.516 | 0.399 | 0.349 | 0.312 |
| SIFT | 0.553 | 0.490 | 0.459 | 0.395 | 0.362 | 0.296 |

Hence, the results on both image matching and visual localization tasks demonstrate that NinjaDesc is able to retain the majority of its utility with respect to the base descriptors.

Ablation Studies

Table 3 already hints that our proposed adversarial descriptor learning framework may generalize to several base descriptors in terms of retaining utility. In this section, we further investigate the generalizability of our method through additional experiments on different types of descriptors, inversion network architectures, and scene categories.

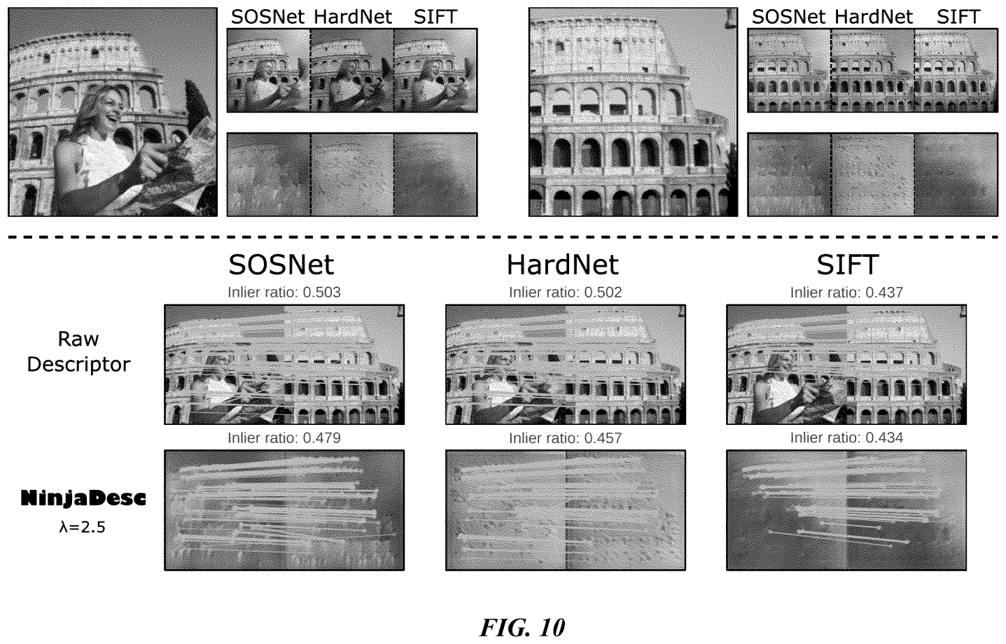

We extend the same experiments from SOSNet [75] in Table 2 to include HardNet [41] and SIFT [37] as well. We report SSIM in Table 4. Similar to the observation for SOSNet, increasing privacy parameter λ reduces reconstruction quality for both HardNet and SIFT as well. FIG. 10 illustrates and example generalization of our proposed adversarial descriptor learning framework across three different base descriptors. The top shows two matching images. Two rows of small images to the right of each of them are the reconstructions. The top and bottom rows are, respectively, the reconstructions from the raw descriptor and from NinjaDesc (λ=2.5) associated with the base descriptor above. The bottom visualizes the matches between the two images on raw descriptors vs. NinjaDesc (λ=2.5) for each of the three base descriptors. In FIG. 10, we qualitatively show the descriptor inversion and correspondence matching result across all three base descriptors. We observe that NinjaDesc derived from all three base descriptors are effective in concealing important contents such as person or landmark compared with the raw base descriptors. The visualization of key-point correspondences between the images also demonstrates the utility retention of our proposed learning framework across different base descriptors.

So far, all experiments are evaluated with the same architecture for the inversion model—the UNet [58]-based network [11, 53]. To verify that NinjaDesc does not overfit to this specific architecture, we conduct a descriptor inversion attack using an inversion model with drastically different architecture, called UResNet, which has a ResNet50 [26] as the encoder backbone and residual decoder blocks. (See the supplementary material.) The results are shown in Table 5, which depicts only SSIM is slightly improved compared to UNet whereas MAE and PSNR remain relatively unaffected. This result illustrate that our proposed method may be not limited by the architectures of the inversion model.

TABLE 4
Reconstruction results on MegaDepth [35]. We compare the
UNet used in this work vs. a different architecture - UResNet.

| | UNet | | | UResNet | | |
|---|---|---|---|---|---|---|
| Arch. | SOSNet | λ = 1.0 | λ = 2.5 | SOSNet | λ = 1.0 | λ = 2.5 |
| MAE (↑) | 0.104 | 0.183 | 0.212 | 0.121 | 0.190 | 0.202 |
| SSIM (↓) | 0.596 | 0.385 | 0.349 | 0.595 | 0.427 | 0.380 |
| PSNR (↓) | 17.904 | 13.367 | 12.010 | 16.533 | 12.753 | 12.299 |

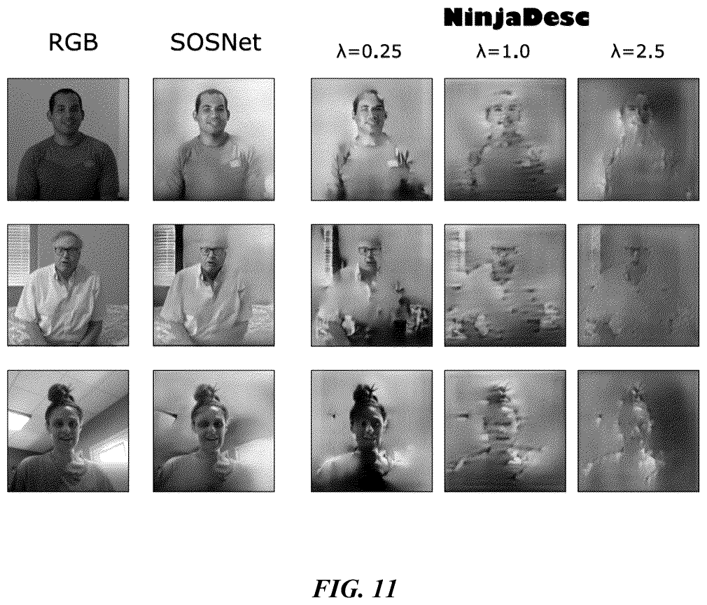

We further show qualitative results on human faces using the Deepfake Detection Challenge (DFDC) [14] dataset. FIG. 11 illustrates example qualitative reconstruction results on faces. Images are cropped frames sampled from videos in the DFDC [14] dataset. FIG. 11 presents the descriptor inversion result using the base descriptors (SOSNet [75]) as well as our NinjaDesc varying in privacy parameter λ. Similar to what we observed in FIG. 8, we see progressing concealment of facial features as we increase λ compared to the reconstruction on SOSNet.

Utility and Privacy Trade-Off

We now describe two experiments we perform to further investigate the utility and privacy trade-off of NinjaDesc.

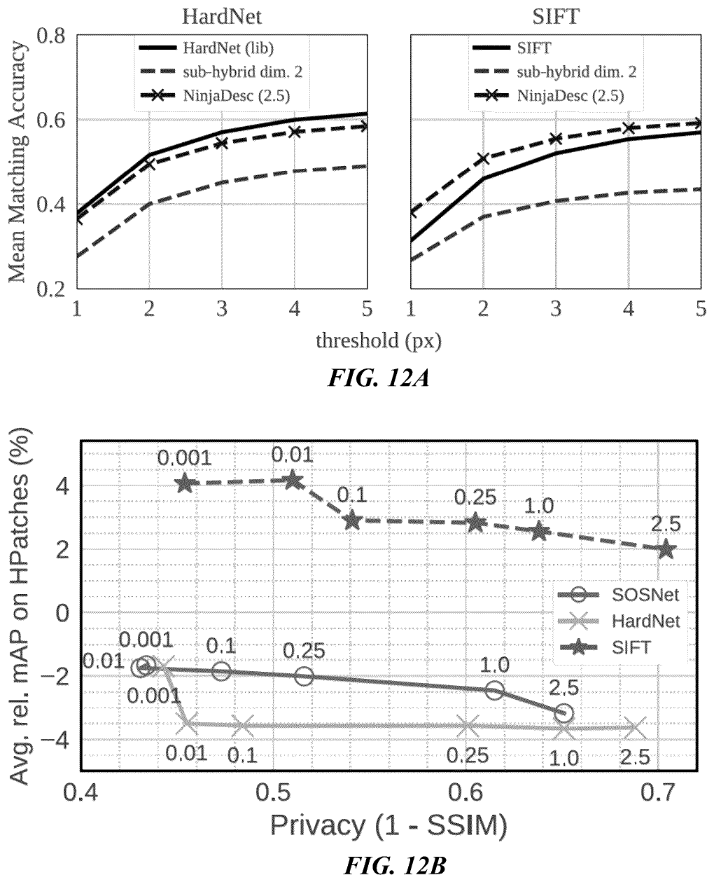

FIGS. 12A-12B illustrate example utility versus privacy trade-off analyses. First, in FIG. 12A, we evaluate the mean matching accuracy (MMA) of NinjaDesc at the highest privacy parameter λ=2.5, for both HardNet [41] and SIFT [37], on the HPatches sequences [6] and compare that with the sub-hybrid lifting method by Dusmanu et al. [18] with low privacy level (dimension=2). Even at a higher privacy level, NinjaDesc significantly outperforms sub-hybrid lifting for both types of descriptors. For NinjaDesc, the drop in MMA with respect to HardNet is also minimal, and even increases with respect to SIFT.

Second, in FIG. 12B we perform a detailed utility versus privacy trade-off analysis on NinjaDesc for all three base descriptors. The y-axis is the average difference in NinjaDesc's mAP across the three tasks in HPatches in FIG. 9, and the x-axis is the privacy measured by 1-SSIM [11]. We plot the results varying the privacy parameter. For SOSNet and HardNet, the drop in utility (<4%) is a magnitude less than the gain in privacy (30%), indicating an optimal tradeoff. Interestingly, for SIFT we see a net gain in utility for all λ (positive values in the y-axis). This may be due to the SOSNetlike utility training, improving the verification and retrieval of NinjaDesc beyond the handcrafted SIFT. Full HPatches results for HardNet and SIFT are in the supplementary.

Limitations

NinjaDesc may only affect the descriptors, and not the key-point locations. Therefore, it may not prevent inferring scene structures from the patterns of key-point locations themselves [38, 70]. Also, some level of structure may still be revealed where key-points are very dense, e.g., the venetian blinds in the second example of FIG. 11.

Conclusions

The embodiments disclosed herein introduced a novel adversarial learning framework for visual descriptors to prevent reconstructing original input image content from the descriptors. We experimentally validated that the obtained descriptors deteriorate the descriptor inversion quality with only marginal drop in utility. We also empirically demonstrated that we may control the trade-offs between utility and non-invertibility using our framework, by changing a single parameter that weighs the adversarial loss. The ablation study using different types of visual descriptors and image reconstruction network architecture demonstrates the generalizability of our method. Our proposed pipeline may enhance the security of computer vision systems that use visual descriptors, and may have great potential to be extended for other applications beyond local descriptor encoding. Our observation suggests that the visual descriptors contain more information than what is needed for matching, which may be removed by the adversarial learning process. It may open up a new opportunity in general representation learning for obtaining representations with only necessary information to preserve privacy.

Supplementary Material

We first provide a comparison of our NinjaDesc and the base descriptor on the 3D reconstruction task using SfM. Next, we report the full HPatches results using HardNet [41] and SIFT [37] as the base descriptors. In addition to our results on Aachen-Day-Night v1.1 in the main paper, we also provide our results on Aachen-Day-Night v1.0. Finally, we illustrate the detailed architecture for the inverse models.

Table 6 shows a quantitative comparison of our content-concealing NinjaDesc and the base descriptor SOSNet [75] on the SfM reconstruction task using the landmarks dataset for local feature benchmarking [64]. As can be seen, decrease in the performance for our content-concealing NinjaDesc is only marginal for all metrics.

TABLE 5
3D reconstruction statistics on the local feature evaluation benchmark
[64]. Number in parenthesis is the privacy parameter λ.

| | | Reg. | Sparse | | Track | |
|---|---|---|---|---|---|---|
| Dataset | Method | images | points | Observations | length | Reproj.error |
| South-Building | SOSNet | 128 | 101,568 | 638,731 | 6.29 | 0.56 |
| 128 images | NinjaDesc | 128 | 105,780 | 652,869 | 6.17 | 0.56 |
| | (1.0) | | | | | |
| | NinjaDesc | 128 | 105,961 | 653,449 | 6.17 | 0.56 |
| | (2.5) | | | | | |
| Madrid Metropolis | SOSNet | 572 | 95,733 | 672,836 | 7.03 | 0.62 |
| 1344 images | NinjaDesc | 566 | 94,374 | 668,148 | 7.08 | 0.64 |
| | (1.0) | | | | | |
| | NinjaDesc | 564 | 94,104 | 667,387 | 7.09 | 0.63 |
| | (2.5) | | | | | |
| Gendarmen-markt | SOSNet | 1076 | 246,503 | 1,660,694 | 6.74 | 0.74 |
| 1463 images | NinjaDesc | 1087 | 312,469 | 1,901,060 | 6.08 | 0.75 |
| | (1.0) | | | | | |
| | NinjaDesc | 1030 | 340,144 | 1,871,726 | 5.50 | 0.77 |
| | (2.5) | | | | | |
| Tower of London | SOSNet | 825 | 200,447 | 1,733,994 | 8.65 | 0.62 |
| 1463 images | NinjaDesc | 797 | 198,767 | 1,727,785 | 8.69 | 0.62 |
| | (1.0) | | | | | |
| | NinjaDesc | 837 | 218,888 | 1,792,908 | 8.19 | 0.64 |
| | (2.5) | | | | | |

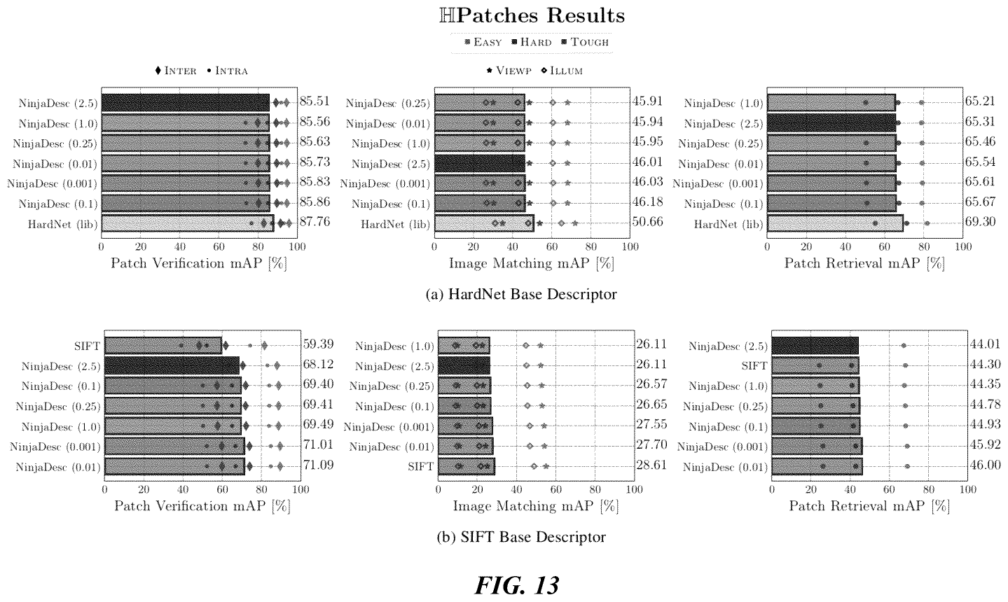

FIG. 13 illustrates example HPatches evaluation results. For each base descriptor (HardNet [41] and SIFT [37]), we compare with NinjaDesc, with 5 different levels of privacy parameter λ (indicated by the number in parenthesis). All results are from models trained on the liberty subset of the UBC patches [22] dataset, apart from SIFT which is handcrafted, and we use the Kornia [57] GPU implementation evaluated on 32×32 patches. FIG. 13 illustrates our full evaluation results on HPatches using HardNet [41] and SIFT [37] as the base descriptors for NinjaDesc, in addition to the results using SOSNet [75] provided previously in FIG. 9. Similar to the results for SOSNet [75], we observe little drop in accuracy for NinjaDesc overall compared to the original base descriptors, ranging from low (λ=0.1) to high (λ=2.5) privacy parameters.

In Table 3, we report the result of NinjaDesc on Aachen-Day-Night v1.1 dataset. The v1.1 is updated with more accurate ground-truths compared to the older v1.0. Because Dusmanu et al. [18] performed evaluation on the v1.0, we also provide our results on v1.0 in Table 7 for better comparison.

TABLE 7
Visual localization results on Aachen-Day-Night v1.0 [63].
‘Raw’ corresponds to the base descriptor in each column,
followed by three λ vales (0.1, 1.0, 2.5) for NinjaDesc.

| | | | Accuracy @ Thresholds (%) | | |
|---|---|---|---|---|---|
| | | Method | 0.25 m, ₂° | 0.5 m, ₅° | 5.0 m, 10° |
| Query | NNs | Base Desc | SOS/Hard/SIFT | SOS/Hard/SIFT | SOS/Hard/SIFT |
| Day | 20 | Raw | 85.1/85.4/84.3 | 92.7/93.1/92.7 | 97.3/98.2/97.6 |
| (824) | | λ = 0.1 | 85.4/84.7/82.0 | 92.5/91.9/91.1 | 97.5/96.8/96.4 |
| | | λ = 1.0 | 84.7/84.3/82.9 | 92.4/91.9/91.0 | 97.2/96.7/96.1 |
| | | λ = 2.5 | 84.6/83.7/82.5 | 92.4/92.0/91.0 | 97.1/96.8/96.0 |
| | 50 | Raw | 85.9/86.8/86.0 | 92.5/93.7/94.1 | 97.3/98.1/98.2 |
| | | λ = 0.1 | 85.2/85.2/84.2 | 92.2/92.4/91.4 | 97.1/97.1/96.6 |
| | | λ = 1.0 | 84.7/85.7/83.4 | 92.2/92.6/91.6 | 97.2/96.7/96.7 |
| | | λ = 2.5 | 85.6/85.3/83.6 | 92.7/91.7/91.1 | 97.3/96.8/96.2 |
| Night | 20 | Raw | 51.0/57.2/55.1 | 65.3/68.4/67.3 | 70.4/76.5/74.5 |
| (98) | | λ = 0.1 | 51.0/45.9/45.9 | 62.2/56.1/54.1 | 68.4/62.2/63.3 |
| | | λ = 1.0 | 50.0/43.9/44.9 | 62.2/54.1/56.1 | 66.3/62.2/64.3 |
| | | λ = 2.5 | 48.0/44.9/44.9 | 58.2/59.2/52.0 | 65.3/65.3/62.2 |
| | 50 | Raw | 48.0/51.0/54.1 | 59.2/64.3/65.3 | 65.3/68.4/74.5 |
| | | λ = 0.1 | 41.8/39.8/41.8 | 52.0/51.0/52.0 | 60.2/56.1/60.2 |
| | | λ = 1.0 | 43.9/39.8/43.9 | 54.1/50.0/54.1 | 63.3/58.2/63.3 |
| | | λ = 2.5 | 42.9/40.8/42.9 | 52.0/50.0/52.0 | 61.2/56.1/58.2 |

We also performed the following additional content-concealment experiments.

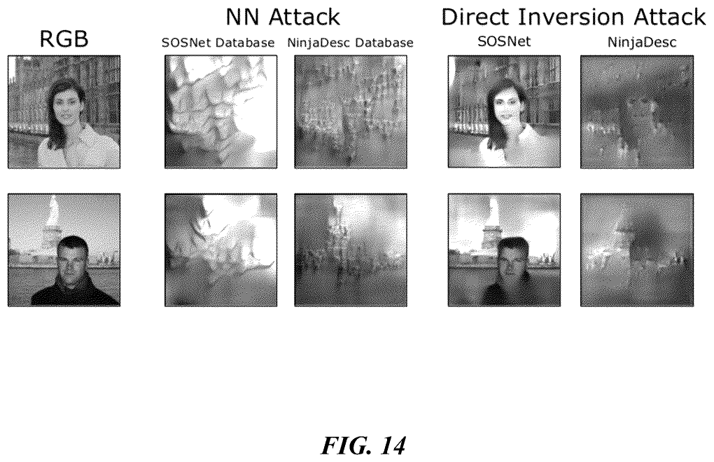

Nearest-neighbor attack. FIG. 14 illustrates examples of NN attack. For NN attack, we show results using SOSNet and our NinjaDesc descriptors to form the database. Two examples of nearest-neighbour (NN) attack similar to that in [16] using a database of 128,000 existing descriptors are shown in FIG. 14. In both NN attack scenarios, the reconstruction is significantly deteriorated, as it is non-trivial to compute distances between the two spaces, cf. oracle attack analysis below. Note we use λ=2.5 for all our experiments.

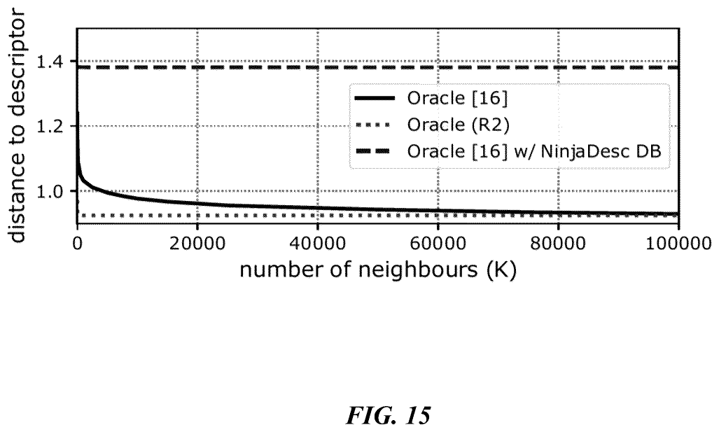

Oracle attack distance analysis. FIG. 15 illustrates example distances to the original descriptor (SOSNet) of the nearest-neighbor retrieved by three variants of the oracle attack. The distances to the original descriptor using the oracle attack following [16] is plotted in FIG. 15. We also show another oracle, which differs from [16] in that the K neighbours are first matched using the NinjaDesc database, then their corresponding SOSNet descriptor pairings are retrieved. For completeness, we also plot the results of only using NinjaDesc descriptors as the database.

We observe that the distance decreases as K increases for SOSNet database like FIG. 10 in [16]. However, we argue that this alone does not validate manifold folding. Rather, as K increases, we approach the limit of the distance to the real NN of the original (SOSNet) descriptor, regardless of the private (NinjaDesc) representation. This limit is achieved by the new oracle, where the closest NinjaDesc (i.e., the corresponding SOSNet) database descriptor is always retrieved, for most K values. If the oracle in [16] uses the NinjaDesc database, the distance remains large. This may be because unlike [16], NinjaNet may map the original feature space to a completely new one via learned nonlinear transformations, and is thus robust to distance calculation across the two descriptor spaces.

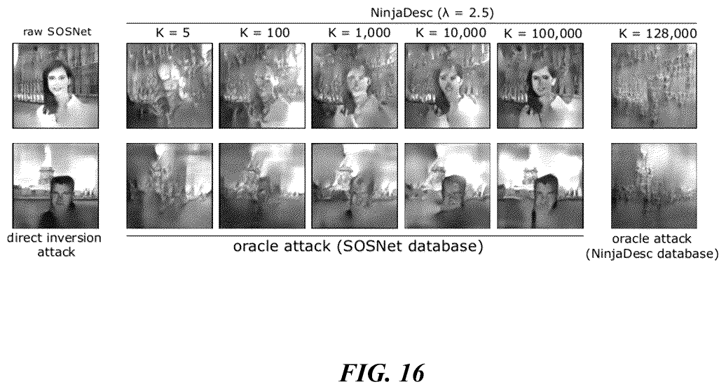

FIG. 16 illustrates examples of oracle attack with respect to number of neighbors. FIG. 16 shows how our reconstruction improves as K increases in oracle attack [16]. Still, even with very large K, it is visibly worse than that from direct inversion or the original image. For the oracle with NinjaDesc database (last column), the reconstruction is highly privacy-preserving. As noted in [16], an oracle attack is impractical as the attacker does not have access to the original descriptors.

Next we disclose the detailed architectures of the descriptor inversion models.

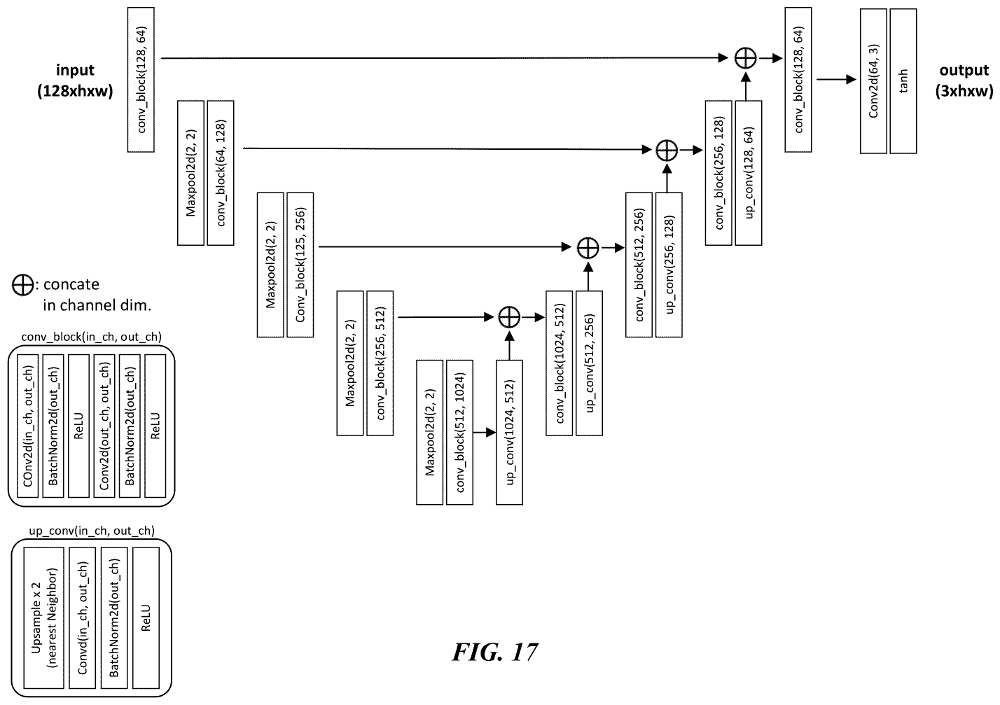

UNet. FIG. 17 illustrates an example architecture of UNet. The architecture of the UNet-based descriptor inversion model, which is also used in [11, 53], is shown in FIG. 17.

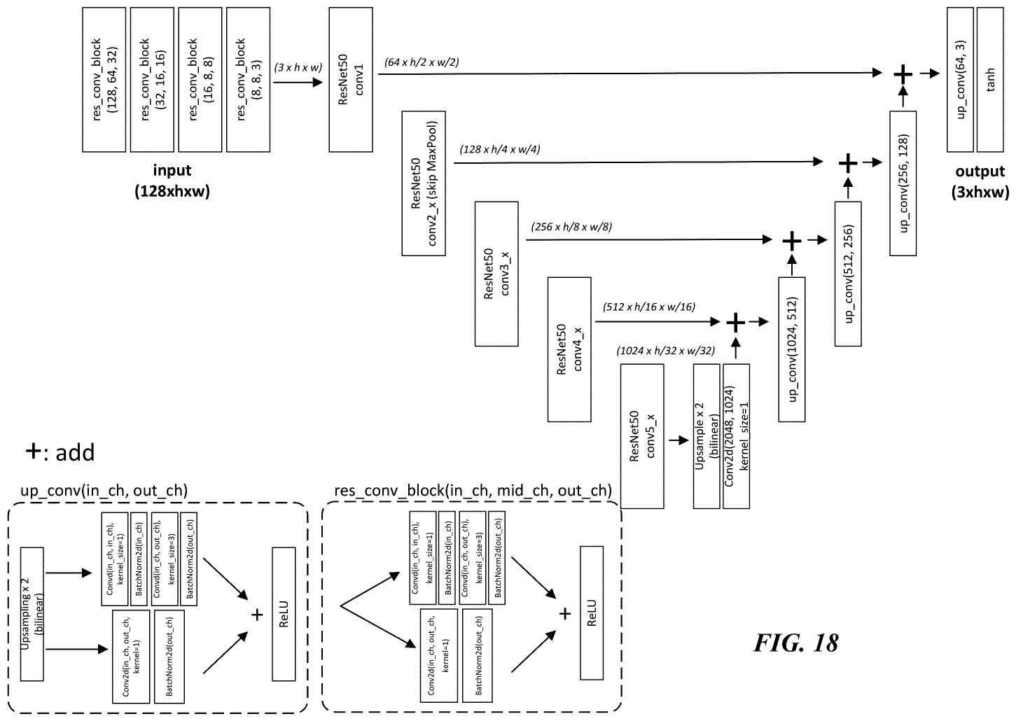

UResNet. FIG. 18 illustrates an example architecture of the descriptor inversion model based on UResNet used for the ablation study. The overall “U” shape of UResNet is similar to UNet, but each convolution block is drastically different. We use the 5 stages of ResNet50 [26] (pretrained on ImageNet [12]) {conv1, conv2 x, conv3 x, conv4 x, conv4 x} as the 5 encoding/down-sampling blocks, except for conv2 x we remove the MaxPool2d so that each encoding block corresponds to a ½ down-sampling in resolution. Since ResNet50 takes in RGB image as input (which has shape of 3×h×w, whereas the sparse feature maps are of shape 128×h×w), we pre-process the input with 4 additional basic redisual blocks denoted by res cony block in FIG. 18. The up-sampling decoder blocks (denoted by up cony) are also residual blocks with an addition input up-sampling layer using bilinear interpolation. In contrast to UNet, the skip connections in our UResNet are performed by additions, rather than concatenations

### REFERENCES

The following list of references correspond to the citations above:
[1] Sameer Agarwal, Yasutaka Furukawa, Noah Snavely, Ian Simon, Brian Curless, Steven M Seitz, and Richard Szeliski. Building rome in a day. Communications of the ACM, 2011.
[2] Alexandre Alahi, Raphael Ortiz, and Pierre Vandergheynst. Freak: Fast retina keypoint. In CVPR, 2012.
[3] Relja Arandjelovic′, Petr Gronat, Akihiko Torii, Tomas Pajdla, and Josef Sivic. NetVLAD: CNN architecture for weakly supervised place recognition. In CVPR, 2016.
[4] Relja Arandjelovic′ and Andrew Zisserman. DisLocation: Scalable descriptor distinctiveness for location recognition. In ACCV, 2014.
[5] Sungyong Baik, Hyo Jin Kim, Tianwei Shen, Eddy Ilg, Kyoung Mu Lee, and Christopher Sweeney. Domain adaptation of learned features for visual localization. In BMVC, 2020.
[6] Vassileios Balntas, Karel Lenc, Andrea Vedaldi, and Krystian Mikolajczyk. HPatches: A benchmark and evaluation of handcrafted and learned local descriptors. In CVPR, 2017.
[7] Axel Barroso-Laguna, Edgar Riba, Daniel Ponsa, and Krystian Mikolajczyk. Key.Net: Keypoint detection by handcrafted and learned cnn filters. In ICCV, 2019.
[8] Michael Calonder, Vincent Lepetit, Christoph Strecha, and Pascal Fua. BRIEF: Binary robust independent elementary features. In ECCV, 2010.
[9] Kunal Chelani, Fredrik Kahl, and Torsten Sattler. How privacy-preserving are line clouds? Recovering scene details from 3d lines. In CVPR, 2021.
[10] Emmanuel d'Angelo, Laurent Jacques, Alexandre Alahi, and Pierre Vandergheynst. From bits to images: Inversion of local binary descriptors. TPAMI, 36(5):874-887, 2013.
[11] Deeksha Dangwal, Vincent T. Lee, Hyo Jin Kim, Tianwei Shen, Meghan Cowan, Rajvi Shah, Caroline Trippel, Brandon Reagen, Timothy Sherwood, Vasileios Balntas, Armin Alaghi, and Eddy Ilg. Analysis and mitigations of reverse engineering attacks on local feature descriptors. In BMVC, 2021.
[12] Jia Deng, Wei Dong, Richard Socher, Li-Jia Li, Kai Li, and Li Fei-Fei. ImageNet: A large-scale hierarchical image database. In CVPR, 2009.
[13] Daniel DeTone, Tomasz Malisiewicz, and Andrew Rabinovich. SuperPoint: Self-supervised interest point detection and description. In CVPR Workshops, 2018.
[14] Brian Dolhansky, Joanna Bitton, Ben Pflaum, Jikuo Lu, Russ Howes, Menglin Wang, and Cristian Canton-Ferrer. The deepfake detection challenge dataset. CoRR, abs/2006.07397, 2020.
[15] Jing Dong, Erik Nelson, Vadim Indelman, Nathan Michael, and Frank Dellaert. Distributed real-time cooperative localization and mapping using an uncertainty-aware expectation maximization approach. In ICRA, 2015.
[16] Alexey Dosovitskiy and Thomas Brox. Inverting visual representations with convolutional networks. In CVPR, 2016.
[17] Mihai Dusmanu, Ignacio Rocco, Tomas Pajdla, Marc Pollefeys, Josef Sivic, Akihiko Torii, and Torsten Sattler. D2-Net: A trainable cnn for joint detection and description of local features. In CVPR, 2019.
[18] Mihai Dusmanu, Johannes L Scho\ddot{ }nberger, Sudipta N Sinha, and Marc Pollefeys. Privacy-preserving visual feature descriptors through adversarial affine subspace embedding. In CVPR, 2021.
[19] Zekeriya Erkin, Martin Franz, Jorge Guajardo, Stefan Katzenbeisser, Inald Lagendijk, and Tomas Toft. Privacy-preserving face recognition. In International symposium on privacy enhancing technologies symposium, 2009.
[20] Marcel Geppert, Viktor Larsson, Pablo Speciale, Johannes L Scho\ddot{ }nberger, and Marc Pollefeys. Privacy preserving structure-from-motion. In ECCV, 2020.
[21] Marcel Geppert, Viktor Larsson, Pablo Speciale, Johannes L Schonberger, and Marc Pollefeys. Privacy preserving localization and mapping from uncalibrated cameras. In CVPR, 2021.
[22] Michael Goesele, Noah Snavely, Brian Curless, Hugues Hoppe, and Steven M. Seitz. Multi-view stereo for community photo collections. In CVPR, 2007.
[23] Ian J. Goodfellow, Jean Pouget-Abadie, Mehdi Mirza, Bing Xu, David Warde-Farley, Sherjil Ozair, Aaron Courville, and Yoshua Bengio. Generative adversarial networks. In NIPS, 2014.
[24] Sam Hare, Amir Saffari, and Philip H S Torr. Efficient online structured output learning for keypoint-based object tracking. In CVPR, 2012.
[25] Christopher G Harris, Mike Stephens, et al. A combined corner and edge detector. In Alvey vision conference, volume 15, 1988.
[26] Kaiming He, Xiangyu Zhang, Shaoqing Ren, and Jian Sun. Deep residual learning for image recognition. In CVPR, 2016.
[27] Carlos Hinojosa, Juan Carlos Niebles, and Henry Arguello. Learning privacy-preserving optics for human pose estimation. In ICCV, 2021.
[28] Martin Humenberger, Yohann Cabon, Nicolas Guerin, Julien Morat, Je′rôme Revaud, Philippe Rerole, Noe′Pion, Cesar de Souza, Vincent Leroy, and Gabriela Csurka. Robust image retrieval-based visual localization using kapture, 2020.
[29] Herve′ Je′gou, Matthijs Douze, and Cordelia Schmid. Hamming embedding and weak geometry consistency for large scale image search. In ECCV, 2008.
[30] Yuhe Jin, Dmytro Mishkin, Anastasiia Mishchuk, Jiri Matas, Pascal Fua, Kwang Moo Yi, and Eduard Trulls. Image matching across wide baselines: From paper to practice. IJCV, 2021.
[31] Hiroharu Kato and Tatsuya Harada. Image reconstruction from bag-of-visual-words. In CVPR, 2014.
[32] Hyo Jin Kim, Enrique Dunn, and Jan-Michael Frahm. Learned contextual feature reweighting for image geolocalization. In CVPR, 2017.
[33] Diederik P Kingma and Jimmy Ba. Adam: A method for stochastic optimization. In ICLR, 2015.
[34] Alex Krizhevsky, Ilya Sutskever, and Geoffrey E Hinton. ImageNet classification with deep convolutional neural networks. Communications of the ACM, 2017.
[35] Zhengqi Li and Noah Snavely. MegaDepth: Learning single-view depth prediction from internet photos. In CVPR, 2018.
[36] Ce Liu, Jenny Yuen, and Antonio Torralba. SIFT flow: Dense correspondence across scenes and its applications. TPAMI, 2010.
[37] David G. Lowe. Distinctive image features from scale-invariant keypoints. In IJCV, 2004.
[38] Zixin Luo, Tianwei Shen, Lei Zhou, Jiahui Zhang, Yao, Shiwei Li, Tian Fang, and Long Quan. ContextDesc: Local descriptor augmentation with cross-modality context. In CVPR, 2019.
[39] Aravindh Mahendran and Andrea Vedaldi. Understanding deep image representations by inverting them. In CVPR, 2015.
[40] Christopher Mei, Gabe Sibley, Mark Cummins, Paul Newman, and Ian Reid. Rslam: A system for large-scale mapping in constant-time using stereo. IJCV, 2011.
[41] Anastasiya Mishchuk, Dmytro Mishkin, Filip Radenovic′, and Jir\check{ }i Matas. Working hard to know your neighbor's margins: Local descriptor learning loss. In NIPS, 2017.
[42] Raul Mur-Artal, J. M. M. Montiel, and Juan D. Tardos. ORB-SLAM: A versatile and accurate monocular slam system. IEEE Transactions on Robotics, 31(5):1147-1163, Oct 2015.
[43] Raul Mur-Artal and Juan D Tardós. ORB-SLAM2: An open-source slam system for monocular, stereo, and RGB-D cameras. IEEE Transactions on Robotics, 2017.
[44] Georg Nebehay and Roman Pflugfelder. Consensus-based matching and tracking of keypoints for object tracking. In WACV, 2014.
[45] Richard A. Newcombe, Steven J. Lovegrove, and Andrew J. Davison. DTAM: Dense tracking and mapping in real-time. In ICCV, 2011.
[46] Tony Ng, Vassileios Balntas, Yurun Tian, and Krystian Mikolajczyk. SOLAR: Second-order loss and attention for image retrieval. In ECCV, 2020.
[47] Hyeonwoo Noh, Andre′ Araujo, Jack Sim, Tobias Weyand, and Bohyung Han. Image retrieval with deep local features and attention-based keypoints. In ICCV, 2017.
[48] Timo Ojala, Matti Pietikainen, and Topi Maenpaa. Multiresolution gray-scale and rotation invariant texture classification with local binary patterns. TPAMI, 2002.
[49] Luc Oth, Paul Furgale, Laurent Kneip, and Roland Siegwart. Rolling shutter camera calibration. In CVPR, 2013.
[50] Adam Paszke, Sam Gross, Francisco Massa, Adam Lerer, James Bradbury, Gregory Chanan, Trevor Killeen, Zeming Lin, Natalia Gimelshein, Luca Antiga, Alban Desmaison, Andreas Kopf, Edward Yang, Zachary DeVito, Martin Raison, Alykhan Tejani, Sasank Chilamkurthy, Benoit Steiner, Lu Fang, Junjie Bai, and Soumith Chintala. PyTorch: An imperative style, high-performance deep learning library. In NeurIPS, 2019.
[51] Federico Pernici and Alberto Del Bimbo. Object tracking by oversampling local features. TPAMI, 2013.
[52] Francesco Pittaluga, Sanjeev Koppal, and Ayan Chakrabarti. Learning privacy preserving encodings through adversarial training. In WACV, 2019.
[53] Francesco Pittaluga, Sanjeev J Koppal, Sing Bing Kang, and Sudipta N Sinha. Revealing scenes by inverting structure from motion reconstructions. In CVPR, 2019.
[54] Horia Porav, Will Maddern, and Paul Newman. Adversarial training for adverse conditions: Robust metric localisation using appearance transfer. In ICRA, 2018.
[55] Jerome Revaud, Jon Almazán, Rafael Sampaio de Rezende, and Ce′sar Roberto de Souza. Learning with average precision: Training image retrieval with a listwise loss. In ICCV, 2019.
[56] Jerome Revaud, Philippe Weinzaepfel, Ce′sar De Souza, Noe Pion, Gabriela Csurka, Yohann Cabon, and Martin Humenberger. R2D2: Repeatable and reliable detector and descriptor. In NeurIPS, 2019.
[57] Edgar Riba, Dmytro Mishkin, Daniel Ponsa, Ethan Rublee, and Gary Bradski. Kornia: an open source differentiable computer vision library for PyTorch. In WACV, 2020.
[58] Olaf Ronneberger, Philipp Fischer, and Thomas Brox. U-Net: Convolutional networks for biomedical image segmentation. In MICCAI. Springer, 2015.
[59] Proteek Chandan Roy and Vishnu Naresh Boddeti. Mitigating information leakage in image representations: A maximum entropy approach. In CVPR, 2019.
[60] Ahmad-Reza Sadeghi, Thomas Schneider, and Immo Wehrenberg. Efficient privacy-preserving face recognition. In International Conference on Information Security and Cryptology, 2009.
[61] Paul-Edouard Sarlin, Daniel DeTone, Tomasz Malisiewicz, and Andrew Rabinovich. SuperGlue: Learning feature matching with graph neural networks. In CVPR, 2020.
[62] Torsten Sattler, Bastian Leibe, and Leif Kobbelt. Efficient & effective prioritized matching for large-scale image-based localization. TPAMI, 39(9):1744-1756, 2017.
[63] Torsten Sattler, Will Maddern, Carl Toft, Akihiko Torii, Lars Hammarstrand, Erik Stenborg, Daniel Safari, Masatoshi Okutomi, Marc Pollefeys, Josef Sivic, Fredrik Kahl, and Tomas Pajdla. Benchmarking 6dof outdoor visual localization in changing conditions. In CVPR, 2018.
[64] Johannes L Schonberger, Hans Hardmeier, Torsten Sattler, and Marc Pollefeys. Comparative evaluation of hand-crafted and learned local features. In CVPR, 2017.
[65] Johannes L. Scho\ddot{ }nberger and Jan-Michael Frahm. Structure-from-motion revisited. In CVPR, 2016.
[66] Mikiya Shibuya, Shinya Sumikura, and Ken Sakurada. Privacy preserving visual SLAM. In ECCV, 2020.
[67] Oriane Sime′oni, Yannis Avrithis, and Ondrej Chum. Local features and visual words emerge in activations. In CVPR, 2019.
[68] Karen Simonyan and Andrew Zisserman. Very deep convolutional networks for large-scale image recognition. In ICLR, 2015.
[69] Josef Sivic and Andrew Zisserman. Video google: A text retrieval approach to object matching in videos. In ICCV, 2003.
[70] Pablo Speciale, Johannes L Schonberger, Sing Bing Kang, Sudipta N Sinha, and Marc Pollefeys. Privacy preserving image-based localization. In CVPR, 2019.
[71] Pablo Speciale, Johannes L Schonberger, Sudipta N Sinha, and Marc Pollefeys. Privacy preserving image queries for camera localization. In CVPR, 2019.
[72] Chris Sweeney, Tobias Hollerer, and Matthew Turk. Theia: A fast and scalable structure-from-motion library. In Proceedings of the 23rd ACM International Conference on Multimedia, MM ′15, page 693-696, 2015.
[73] Yurun Tian, Axel Barroso-Laguna, Tony Ng, Vassileios Bal-ntas, and Krystian Mikolajczyk. HyNet: Learning local descriptor with hybrid similarity measure and triplet loss. In NeurIPS, 2020.
[74] Yurun Tian, Bin Fan, and Fuchao Wu. L2-Net: Deep learning of discriminative patch descriptor in Euclidean space. In CVPR, 2017.
[75] Yurun Tian, Xin Yu, Bin Fan, Wu. Fuchao, Huub Heijnen, and Vassileios Balntas. SOSNet: Second order similarity regularization for local descriptor learning. In CVPR, 2019.
[76] Carl Toft, Will Maddern, Akihiko Torii, Lars Hammarstrand, Erik Stenborg, Daniel Safari, Masatoshi Okutomi, Marc Pollefeys, Josef Sivic, Tomas Pajdla, Fredrik Kahl, and Torsten Sattler. Long-term visual localization revisited. TPAMI, 2020.
[77] Carl Toft, Daniyar Turmukhambetov, Torsten Sattler, Fredrik Kahl, and Gabriel J Brostow. Single-image depth prediction makes feature matching easier. In ECCV, 2020.
[78] Giorgos Tolias, Yannis Avrithis, and Herve Jegou. To aggregate or not to aggregate: Selective match kernels for image search. In ICCV, 2013.
[79] Giorgos Tolias, Tomas Jenicek, and Ondrej Chum. Learning and aggregating deep local descriptors for instance-level recognition. In ECCV, 2020.
[80] Carl Vondrick, Aditya Khosla, Tomasz Malisiewicz, and Antonio Torralba. Hoggles: Visualizing object detection features. In ICCV, 2013.
[81] Philippe Weinzaepfel, Herve Jegou, and Patrick Perez. Reconstructing an image from its local descriptors. In CVPR, 2011.
[82] Taihong Xiao, Yi-Hsuan Tsai, Kihyuk Sohn, Manmohan Chandraker, and Ming-Hsuan Yang. Adversarial learning of privacy-preserving and task-oriented representations. In AAAI, 2020.
[83] Qizhe Xie, Zihang Dai, Yulun Du, Eduard Hovy, and Graham Neubig. Controllable invariance through adversarial feature learning. In NIPS, 2017.
[84] Ryo Yonetani, Vishnu Naresh Boddeti, Kris M Kitani, and Yoichi Sato. Privacy-preserving visual learning using doubly permuted homomorphic encryption. In ICCV, 2017.
[85] Zichao Zhang, Torsten Sattler, and Davide Scaramuzza. Reference pose generation for long-term visual localization via learned features and view synthesis. IJCV, 2020.
[86] Qiang Zhu, Mei-Chen Yeh, Kwang-Ting Cheng, and Shai Avidan. Fast human detection using a cascade of histograms of oriented gradients. In CVPR, 2006.
   Generating Accessible Subtitles/Signs with AR Devices

In particular embodiments, one or more computing systems (e.g., a social-networking system 160 or an AR platform 140) may making auxiliary visual content more accessible for users by overlaying AR content via the users' AR glasses which have one or more cameras, a microphone, and optionally integrated headphones. When watching TV with subtitles, users typically have to manually adjust the size of subtitles (if at all possible) to adjust for different conditions (e.g., when the text is too small, when their eyes are tired). Sometimes the subtitles are too small or of the wrong color (with respect to the background) so they are unreadable. To address this problem, a computing system can leverage machine learning and the functionality of AR glasses to make subtitles more accessible at any time. For example, the system can provide subtitle AR overlays. The system can also make small subtitles in a movie bigger, or even read the subtitles out loud when the user's eyes are tired. Besides subtitles, the method can be applied to a wide range of applications. For example, the AR overlays can include translations of signs on the street, explanations of meanings of signs/symbols, road signs that are bigger than their real physical sizes, translation of paperwork or other text. Although this disclosure describes generating particular overlays by particular systems in a particular manner, this disclosure contemplates generating any suitable overlay by any suitable system in any suitable manner.

Assume a scenario where the user is watching TV with subtitles (or looking at other text in a real-world environment) and the user is having trouble reading the subtitles/text. The AR platform 140 may have the AR glasses perform the following tasks. In particular embodiments, the AR glasses may perform optical character recognition (OCR) to read the subtitles from the TV screen. Alternatively, if there are no subtitles, the AR platform 140 may listen to the audio and use automatic speech recognition (ASR) to understand audio and then display audio transcripts as subtitles. Also alternatively, if the AR platform 140 has access to the original content, it may just pull the text/script from the original content and project them as subtitles (i.e., no ASR is needed, which saves power).

If the user wants to change the size of the subtitles/AR text, rather than having the user manually change it, the AR platform 140 may instead use eye and face tracking cameras and compute a score indicating how big the subtitles should be displayed based on eye and face tracking data. In particular embodiments, computing the score may be either done as a regression or a classification (with classes being the different possible font sizes). In particular embodiments, features that may be used for prediction may be as follows. One type of features may be historical features for a prior, e.g., what the user is typically using for the font size and whether the user wears glasses or contact lenses. Another type of features may be live features, e.g., whether the user is now wearing their contact lenses and whether the user is squinting a lot (or doing movements with their eyes that indicate that they have trouble reading), or whether the user is staring at the text for a long time. Based on gaze and duration, the AR platform 140 may determine that the text should be made bigger. Another type of features may be environmental features, e.g., time of day, luminosity of the room or screen, etc. These environmental features may also be used to determine whether to render AR subtitles at all. For example, during the middle of the day, users may not need subtitles to read signs. But at dusk or nighttime, it may be more useful to have AR subtitles to read signs.

Once the size score or class has been computed, the AR glasses may reproject the correct sized subtitles on the screen. In particular embodiments, projecting the subtitles may be done by a combination of steps as follows. To begin with, the AR platform 140 may correctly estimate the depth of the screen (e.g., using a stereo camera pair or a machine learning method). Since people may only focus on one depth at a time, the subtitle text may be projected at a virtual depth on the lenses of the AR glasses so it looks like the subtitle text is on the screen. The AR platform 140 may then remove the part of the screen that has the subtitles and write the new subtitles. For writing new subtitles, the AR platform 140 may use a fill-in method (e.g., GAN-based approach) to fill the space that has been removed (i.e., the original subtitles) and that has no text.

Alternatively, if the user is really tired and the language of the subtitles is not available as audio, the AR glasses may use their built-in speakers to replace the written subtitles with an audio track where the audio in the original language is replaced with the text to speech output of the subtitles.

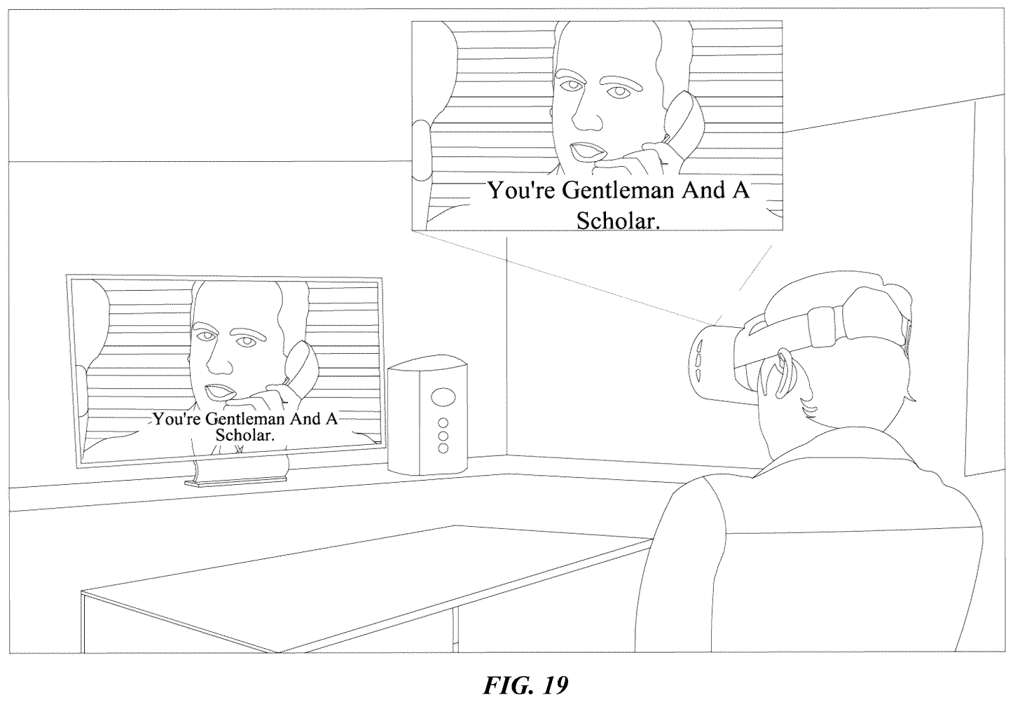

FIG. 19 illustrates an example generation of subtitles. A user may be wearing an AR headset watching TV. There may be subtitles are the TV, e.g., “you're gentle man and a scholar.” However, the font of the subtitles on TV may be small and the system may determine the user is having trouble reading them. As a result, the system may generate accessible subtitles by adjusting the size of the subtitles. As can be seen from FIG. 3, the user's view through the AR headset may include the TV and the subtitles. However, the fond of the newly generated subtitles may be much larger than the original ones on the TV in the real world.

### Intuitive Voice Interaction Enhanced by Eye Tracking

In particular embodiments, one or more computing systems may enable an intuitive, low-friction interaction with head-mounted devices (e.g., smart glasses) using audio (both speaking and listening) combined with eye-tracking functionality. The main technical components/capabilities may include real-time simultaneous localization and mapping, eye-tracking gaze estimation, a new streamlined, self-serve in-the-field eye-tracking calibration flow, real-time microphone data streaming from the smart glasses, and question answering including automatic speech recognition (ASR), question answering component from knowledge graph, product information from public object libraries stored in a database for accurately answering questions related to any specific gazed object, and text-to-speech (TTS). These services may be hosted on remote server and connected to the one or more computing systems executing on the head-mounted devices (e.g., smart glasses) through standard HTTP request. Although this disclosure describes enabling particular interactions by particular systems in a particular manner, this disclosure contemplates enabling any suitable interaction by any suitable system in any suitable manner.

To make using AR glasses more intuitive and thus useful, the main input modality may be voice. But voice input can be awkward to use. To make using AR glasses more intuitive, one may combine voice input with other sensor inputs. For example, cameras may be used for simultaneous localization and mapping of rooms, so the AR glasses can know what's in the room. As another example, smart glasses may know not only what's in the user's field of view (from cameras), but also exactly what the user is looking at in the field of view (FOV) (from gaze tracking).

Beyond the capabilities of today's assistants on smart speakers or mobile phones, AR headsets and smart glasses may have the added context of knowing where a user is and what the user is looking at. By maintaining an object-centric representation of the environment and tracking the user's eye gaze, the one or more computing systems may look up the object at the intersection of the user's eye gaze and use that information to provide the missing context for natural language queries. For example, the user may ask “where can I buy this?” or “what is this made from?” This may be referred to as a “contextual query”, which, when combined with speech recognition from the microphones of the AR headsets and smart glasses and text-to-speech for audio playback, demonstrates an intuitive interface for an artificial-intelligence (AI) assistant.

In particular embodiments, smart glasses may utilize three main components. One component may include location services, i.e., smart glasses may know where they are with respect to other objects in the world. Another component may include eye gaze, i.e., smart glasses may know what the user is looking at. Another component may include object tracking, i.e., smart glasses may know what objects are around them. By combining these components, the one or more computing systems may be able to resolve requests in a low-friction and intuitive way.

In particular embodiments, the one or more computing systems may perform eye tracking calibration for gaze estimation. Eye tracking calibration may be considered a customization of the eye tracking model for a specific user to increase the precision.

Smart glasses may use computer vision to identify objects and determine an object identifier (ID) for the object. Each object ID may be associated with information describing the object, which may be provided by the manufacturer or parsed from a website. Both object ID and the description may be added to a personal knowledge graph, provided by the one or more computing systems. The assistant API may then look up the text that corresponds to the object ID (e.g., product information extracted from a merchant page) and parse the text to predict the best response, which may be then provided along with a prediction of the answer accuracy. This may allow the response to be tailored according to the confidence of the answer score.

In particular embodiments, upon determining the user's gaze, the one or more computing systems may determine what is in the field of view of the cameras of the user's head-mounted device. The one or more computing systems may further use such information to resolve egocentric use cases such as egocentric question and answering.

Conventionally, the user may need to manually select (e.g., type the name of an object) a subject and query new information about it after. Such subject may be from a given list. In particular embodiments, the way for a user to select something of interest may be an open way. The selection may be based on a combination of the user's voice input and a coreference to something in the field of view of the user. In particular embodiments, eye tracking of the user's gaze may be used to determine the coreference. In particular embodiments, the user may not need provide any coreference by voice input and the one or more computing systems may still identify the subject the user is interested. For example, the user may look at a bottle of drink and simply ask “how many calories are there?” The one or more computing systems may determine that the user is interested to know the calories of the drink and provide the corresponding answer.

In particular embodiments, the one or more computing systems may perform object tracking with respect to the user's gaze based on different ways. One way may be using the cameras of the head-mounted device. The cameras may take picture of the user's egocentric view. The one or more computing systems may then determine the objects within the user's field of view and track it. Another way may be using digital training. The one or more computing systems may pre-scan the space, e.g., based on visual data captured by head-mounted devices. The one or more computing systems may then create a high-quality reconstruction of the space, which may provide the required information.

In particular embodiments, the one or more computing systems may perform re-localization. For example, if a user comes back to a room where he was previously located at, the one or more computing systems may use a re-localization algorithm to determine the user's location relative to the room. As a result, the user may have a connection between the user's current location and all the other settings, and objects that already exist in these settings. For example, the user may visit different shops or restaurants. The one or more computing systems may be always able to determine where the user is, which may allow the user to retrieve information around different places the user has been to.

The following is an example of an object being added to a user's personal knowledge graph. A description may be: “This is a brand-name sofa. Its seat cushions are filled with particular foam and particular fiber wadding for more seating comfort. The cover is easy to keep clean since it is removable and can be machine washed. Frame is made of particular materials. Seat cushion is of particular design with particular material. Fabric is 100% cotton. Lining is cotton. Price is $999. Width is 35 inches. Height is 30 inches. Length is 92 inches. Weight is 152 lbs. A user's question can be: “What's the material of the fabric?” The one or more computing systems may reply: “Seat cushions filled with particular foam and particular fiber wadding for more seating comfort.” The answer score may be 0.52768462896347 and it may be answerable with an answerable score of 0.90397053956985.

If a question cannot be answered using the object information provided by the personal knowledge graph, alternative modalities may also be used, such as a public knowledge database, allowing for queries that extend beyond the boundaries of the personal knowledge graph.

To ensure the one or more computing systems has the best possible accuracy for predicting a user's eye gaze, the one or more computing systems may use a new, faster and more streamlined eye calibration method, which may be completed by anybody independently and allow eye vector accuracy to be improved from greater than 5 degrees to less than 1 degree.

### Systems and Methods

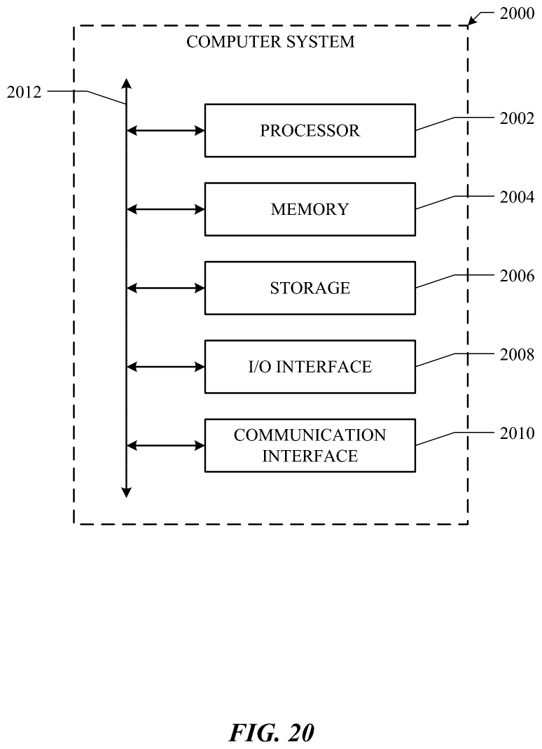

FIG. 20 illustrates an example computer system 2000. In particular embodiments, one or more computer systems 2000 perform one or more steps of one or more methods described or illustrated herein. In particular embodiments, one or more computer systems 2000 provide functionality described or illustrated herein. In particular embodiments, software running on one or more computer systems 2000 performs one or more steps of one or more methods described or illustrated herein or provides functionality described or illustrated herein. Particular embodiments include one or more portions of one or more computer systems 2000. Herein, reference to a computer system may encompass a computing device, and vice versa, where appropriate. Moreover, reference to a computer system may encompass one or more computer systems, where appropriate.

This disclosure contemplates any suitable number of computer systems 2000. This disclosure contemplates computer system 2000 taking any suitable physical form. As example and not by way of limitation, computer system 2000 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 2000 may include one or more computer systems 2000; be unitary or distributed; span multiple locations; span multiple machines; span multiple data centers; or reside in a cloud, which may include one or more cloud components in one or more networks. Where appropriate, one or more computer systems 2000 may perform without substantial spatial or temporal limitation one or more steps of one or more methods described or illustrated herein. As an example and not by way of limitation, one or more computer systems 2000 may perform in real time or in batch mode one or more steps of one or more methods described or illustrated herein. One or more computer systems 2000 may perform at different times or at different locations one or more steps of one or more methods described or illustrated herein, where appropriate.

In particular embodiments, computer system 2000 includes a processor 2002, memory 2004, storage 2006, an input/output (I/O) interface 2008, a communication interface 2010, and a bus 2012. Although this disclosure describes and illustrates a particular computer system having a particular number of particular components in a particular arrangement, this disclosure contemplates any suitable computer system having any suitable number of any suitable components in any suitable arrangement.

In particular embodiments, processor 2002 includes hardware for executing instructions, such as those making up a computer program. As an example and not by way of limitation, to execute instructions, processor 2002 may retrieve (or fetch) the instructions from an internal register, an internal cache, memory 2004, or storage 2006; decode and execute them; and then write one or more results to an internal register, an internal cache, memory 2004, or storage 2006. In particular embodiments, processor 2002 may include one or more internal caches for data, instructions, or addresses. This disclosure contemplates processor 2002 including any suitable number of any suitable internal caches, where appropriate. As an example and not by way of limitation, processor 2002 may include one or more instruction caches, one or more data caches, and one or more translation lookaside buffers (TLBs). Instructions in the instruction caches may be copies of instructions in memory 2004 or storage 2006, and the instruction caches may speed up retrieval of those instructions by processor 2002. Data in the data caches may be copies of data in memory 2004 or storage 2006 for instructions executing at processor 2002 to operate on; the results of previous instructions executed at processor 2002 for access by subsequent instructions executing at processor 2002 or for writing to memory 2004 or storage 2006; or other suitable data. The data caches may speed up read or write operations by processor 2002. The TLBs may speed up virtual-address translation for processor 2002. In particular embodiments, processor 2002 may include one or more internal registers for data, instructions, or addresses. This disclosure contemplates processor 2002 including any suitable number of any suitable internal registers, where appropriate. Where appropriate, processor 2002 may include one or more arithmetic logic units (ALUs); be a multi-core processor; or include one or more processors 2002. Although this disclosure describes and illustrates a particular processor, this disclosure contemplates any suitable processor.

In particular embodiments, memory 2004 includes main memory for storing instructions for processor 2002 to execute or data for processor 2002 to operate on. As an example and not by way of limitation, computer system 2000 may load instructions from storage 2006 or another source (such as, for example, another computer system 2000) to memory 2004. Processor 2002 may then load the instructions from memory 2004 to an internal register or internal cache. To execute the instructions, processor 2002 may retrieve the instructions from the internal register or internal cache and decode them. During or after execution of the instructions, processor 2002 may write one or more results (which may be intermediate or final results) to the internal register or internal cache. Processor 2002 may then write one or more of those results to memory 2004. In particular embodiments, processor 2002 executes only instructions in one or more internal registers or internal caches or in memory 2004 (as opposed to storage 2006 or elsewhere) and operates only on data in one or more internal registers or internal caches or in memory 2004 (as opposed to storage 2006 or elsewhere). One or more memory buses (which may each include an address bus and a data bus) may couple processor 2002 to memory 2004. Bus 2012 may include one or more memory buses, as described below. In particular embodiments, one or more memory management units (MMUs) reside between processor 2002 and memory 2004 and facilitate accesses to memory 2004 requested by processor 2002. In particular embodiments, memory 2004 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 2004 may include one or more memories 2004, where appropriate. Although this disclosure describes and illustrates particular memory, this disclosure contemplates any suitable memory.

In particular embodiments, storage 2006 includes mass storage for data or instructions. As an example and not by way of limitation, storage 2006 may include a hard disk drive (HDD), a floppy disk drive, flash memory, an optical disc, a magneto-optical disc, magnetic tape, or a Universal Serial Bus (USB) drive or a combination of two or more of these. Storage 2006 may include removable or non-removable (or fixed) media, where appropriate. Storage 2006 may be internal or external to computer system 2000, where appropriate. In particular embodiments, storage 2006 is non-volatile, solid-state memory. In particular embodiments, storage 2006 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 2006 taking any suitable physical form. Storage 2006 may include one or more storage control units facilitating communication between processor 2002 and storage 2006, where appropriate. Where appropriate, storage 2006 may include one or more storages 2006. Although this disclosure describes and illustrates particular storage, this disclosure contemplates any suitable storage.

In particular embodiments, I/O interface 2008 includes hardware, software, or both, providing one or more interfaces for communication between computer system 2000 and one or more I/O devices. Computer system 2000 may include one or more of these I/O devices, where appropriate. One or more of these I/O devices may enable communication between a person and computer system 2000. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 2008 for them. Where appropriate, I/O interface 2008 may include one or more device or software drivers enabling processor 2002 to drive one or more of these I/O devices. I/O interface 2008 may include one or more I/O interfaces 2008, where appropriate. Although this disclosure describes and illustrates a particular I/O interface, this disclosure contemplates any suitable I/O interface.

In particular embodiments, communication interface 2010 includes hardware, software, or both providing one or more interfaces for communication (such as, for example, packet-based communication) between computer system 2000 and one or more other computer systems 2000 or one or more networks. As an example and not by way of limitation, communication interface 2010 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 2010 for it. As an example and not by way of limitation, computer system 2000 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 2000 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 2000 may include any suitable communication interface 2010 for any of these networks, where appropriate. Communication interface 2010 may include one or more communication interfaces 2010, where appropriate. Although this disclosure describes and illustrates a particular communication interface, this disclosure contemplates any suitable communication interface.

In particular embodiments, bus 2012 includes hardware, software, or both coupling components of computer system 2000 to each other. As an example and not by way of limitation, bus 2012 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 2012 may include one or more buses 2012, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

### Privacy

In particular embodiments, one or more objects (e.g., content or other types of objects) of a computing system may be associated with one or more privacy settings. The one or more objects may be stored on or otherwise associated with any suitable computing system or application, such as, for example, a social-networking system 160, a VR system 130, a VR platform 140, a third-party system 170, a social-networking application 134, a VR application 136, a messaging application, a photo-sharing application, or any other suitable computing system or application. Although the examples discussed herein are in the context of an online social network, these privacy settings may be applied to any other suitable computing system. Privacy settings (or “access settings”) for an object may be stored in any suitable manner, such as, for example, in association with the object, in an index on an authorization server, in another suitable manner, or any suitable combination thereof. A privacy setting for an object may specify how the object (or particular information associated with the object) can be accessed, stored, or otherwise used (e.g., viewed, shared, modified, copied, executed, surfaced, or identified) within the online social network. When privacy settings for an object allow a particular user or other entity to access that object, the object may be described as being “visible” with respect to that user or other entity. As an example and not by way of limitation, a user of the online social network may specify privacy settings for a user-profile page that identify a set of users that may access work-experience information on the user-profile page, thus excluding other users from accessing that information.

In particular embodiments, privacy settings for an object may specify a “blocked list” of users or other entities that should not be allowed to access certain information associated with the object. In particular embodiments, the blocked list may include third-party entities. The blocked list may specify one or more users or entities for which an object is not visible. As an example and not by way of limitation, a user may specify a set of users who may not access photo albums associated with the user, thus excluding those users from accessing the photo albums (while also possibly allowing certain users not within the specified set of users to access the photo albums). In particular embodiments, privacy settings may be associated with particular social-graph elements. Privacy settings of a social-graph element, such as a node or an edge, may specify how the social-graph element, information associated with the social-graph element, or objects associated with the social-graph element can be accessed using the online social network. As an example and not by way of limitation, a particular photo may have a privacy setting specifying that the photo may be accessed only by users tagged in the photo and friends of the users tagged in the photo. In particular embodiments, privacy settings may allow users to opt in to or opt out of having their content, information, or actions stored/logged by the social-networking system 160 or VR platform 140 or shared with other systems (e.g., a third-party system 170). Although this disclosure describes using particular privacy settings in a particular manner, this disclosure contemplates using any suitable privacy settings in any suitable manner.

In particular embodiments, the social-networking system 160 or VR platform 140 may present a “privacy wizard” (e.g., within a webpage, a module, one or more dialog boxes, or any other suitable interface) to the first user to assist the first user in specifying one or more privacy settings. The privacy wizard may display instructions, suitable privacy-related information, current privacy settings, one or more input fields for accepting one or more inputs from the first user specifying a change or confirmation of privacy settings, or any suitable combination thereof. In particular embodiments, the social-networking system 160 or VR platform 140 may offer a “dashboard” functionality to the first user that may display, to the first user, current privacy settings of the first user. The dashboard functionality may be displayed to the first user at any appropriate time (e.g., following an input from the first user summoning the dashboard functionality, following the occurrence of a particular event or trigger action). The dashboard functionality may allow the first user to modify one or more of the first user's current privacy settings at any time, in any suitable manner (e.g., redirecting the first user to the privacy wizard).

Privacy settings associated with an object may specify any suitable granularity of permitted access or denial of access. As an example and not by way of limitation, access or denial of access may be specified for particular users (e.g., only me, my roommates, my boss), users within a particular degree-of-separation (e.g., friends, friends-of-friends), user groups (e.g., the gaming club, my family), user networks (e.g., employees of particular employers, students or alumni of particular university), all users (“public”), no users (“private”), users of third-party systems 170, particular applications (e.g., third-party applications, external websites), other suitable entities, or any suitable combination thereof. Although this disclosure describes particular granularities of permitted access or denial of access, this disclosure contemplates any suitable granularities of permitted access or denial of access.

In particular embodiments, one or more servers 162 may be authorization/privacy servers for enforcing privacy settings. In response to a request from a user (or other entity) for a particular object stored in a data store 164, the social-networking system 160 may send a request to the data store 164 for the object. The request may identify the user associated with the request and the object may be sent only to the user (or a VR system 130 of the user) if the authorization server determines that the user is authorized to access the object based on the privacy settings associated with the object. If the requesting user is not authorized to access the object, the authorization server may prevent the requested object from being retrieved from the data store 164 or may prevent the requested object from being sent to the user. In the search-query context, an object may be provided as a search result only if the querying user is authorized to access the object, e.g., if the privacy settings for the object allow it to be surfaced to, discovered by, or otherwise visible to the querying user. In particular embodiments, an object may represent content that is visible to a user through a newsfeed of the user. As an example and not by way of limitation, one or more objects may be visible to a user's “Trending” page. In particular embodiments, an object may correspond to a particular user. The object may be content associated with the particular user, or may be the particular user's account or information stored on the social-networking system 160, or other computing system. As an example and not by way of limitation, a first user may view one or more second users of an online social network through a “People You May Know” function of the online social network, or by viewing a list of friends of the first user. As an example and not by way of limitation, a first user may specify that they do not wish to see objects associated with a particular second user in their newsfeed or friends list. If the privacy settings for the object do not allow it to be surfaced to, discovered by, or visible to the user, the object may be excluded from the search results. Although this disclosure describes enforcing privacy settings in a particular manner, this disclosure contemplates enforcing privacy settings in any suitable manner.

In particular embodiments, different objects of the same type associated with a user may have different privacy settings. Different types of objects associated with a user may have different types of privacy settings. As an example and not by way of limitation, a first user may specify that the first user's status updates are public, but any images shared by the first user are visible only to the first user's friends on the online social network. As another example and not by way of limitation, a user may specify different privacy settings for different types of entities, such as individual users, friends-of-friends, followers, user groups, or corporate entities. As another example and not by way of limitation, a first user may specify a group of users that may view videos posted by the first user, while keeping the videos from being visible to the first user's employer. In particular embodiments, different privacy settings may be provided for different user groups or user demographics. As an example and not by way of limitation, a first user may specify that other users who attend the same university as the first user may view the first user's pictures, but that other users who are family members of the first user may not view those same pictures.

In particular embodiments, the social-networking system 160 may provide one or more default privacy settings for each object of a particular object-type. A privacy setting for an object that is set to a default may be changed by a user associated with that object. As an example and not by way of limitation, all images posted by a first user may have a default privacy setting of being visible only to friends of the first user and, for a particular image, the first user may change the privacy setting for the image to be visible to friends and friends-of-friends.

In particular embodiments, privacy settings may allow a first user to specify (e.g., by opting out, by not opting in) whether the social-networking system 160 or VR platform 140 may receive, collect, log, or store particular objects or information associated with the user for any purpose. In particular embodiments, privacy settings may allow the first user to specify whether particular applications or processes may access, store, or use particular objects or information associated with the user. The privacy settings may allow the first user to opt in or opt out of having objects or information accessed, stored, or used by specific applications or processes. The social-networking system 160 or VR platform 140 may access such information in order to provide a particular function or service to the first user, without the social-networking system 160 or VR platform 140 having access to that information for any other purposes. Before accessing, storing, or using such objects or information, the social-networking system 160 or VR platform 140 may prompt the user to provide privacy settings specifying which applications or processes, if any, may access, store, or use the object or information prior to allowing any such action. As an example and not by way of limitation, a first user may transmit a message to a second user via an application related to the online social network (e.g., a messaging app), and may specify privacy settings that such messages should not be stored by the social-networking system 160 or VR platform 140.

In particular embodiments, a user may specify whether particular types of objects or information associated with the first user may be accessed, stored, or used by the social-networking system 160 or VR platform 140. As an example and not by way of limitation, the first user may specify that images sent by the first user through the social-networking system 160 or VR platform 140 may not be stored by the social-networking system 160 or VR platform 140. As another example and not by way of limitation, a first user may specify that messages sent from the first user to a particular second user may not be stored by the social-networking system 160 or VR platform 140. As yet another example and not by way of limitation, a first user may specify that all objects sent via a particular application may be saved by the social-networking system 160 or VR platform 140.

In particular embodiments, privacy settings may allow a first user to specify whether particular objects or information associated with the first user may be accessed from particular VR systems 130 or third-party systems 170. The privacy settings may allow the first user to opt in or opt out of having objects or information accessed from a particular device (e.g., the phone book on a user's smart phone), from a particular application (e.g., a messaging app), or from a particular system (e.g., an email server). The social-networking system 160 or VR platform 140 may provide default privacy settings with respect to each device, system, or application, and/or the first user may be prompted to specify a particular privacy setting for each context. As an example and not by way of limitation, the first user may utilize a location-services feature of the social-networking system 160 or VR platform 140 to provide recommendations for restaurants or other places in proximity to the user. The first user's default privacy settings may specify that the social-networking system 160 or VR platform 140 may use location information provided from a VR system 130 of the first user to provide the location-based services, but that the social-networking system 160 or VR platform 140 may not store the location information of the first user or provide it to any third-party system 170. The first user may then update the privacy settings to allow location information to be used by a third-party image-sharing application in order to geo-tag photos.

In particular embodiments, privacy settings may allow a user to specify one or more geographic locations from which objects can be accessed. Access or denial of access to the objects may depend on the geographic location of a user who is attempting to access the objects. As an example and not by way of limitation, a user may share an object and specify that only users in the same city may access or view the object. As another example and not by way of limitation, a first user may share an object and specify that the object is visible to second users only while the first user is in a particular location. If the first user leaves the particular location, the object may no longer be visible to the second users. As another example and not by way of limitation, a first user may specify that an object is visible only to second users within a threshold distance from the first user. If the first user subsequently changes location, the original second users with access to the object may lose access, while a new group of second users may gain access as they come within the threshold distance of the first user.

In particular embodiments, the social-networking system 160 or VR platform 140 may have functionalities that may use, as inputs, personal or biometric information of a user for user-authentication or experience-personalization purposes. A user may opt to make use of these functionalities to enhance their experience on the online social network. As an example and not by way of limitation, a user may provide personal or biometric information to the social-networking system 160 or VR platform 140. The user's privacy settings may specify that such information may be used only for particular processes, such as authentication, and further specify that such information may not be shared with any third-party system 170 or used for other processes or applications associated with the social-networking system 160 or VR platform 140. As another example and not by way of limitation, the social-networking system 160 may provide a functionality for a user to provide voice-print recordings to the online social network. As an example and not by way of limitation, if a user wishes to utilize this function of the online social network, the user may provide a voice recording of his or her own voice to provide a status update on the online social network. The recording of the voice-input may be compared to a voice print of the user to determine what words were spoken by the user. The user's privacy setting may specify that such voice recording may be used only for voice-input purposes (e.g., to authenticate the user, to send voice messages, to improve voice recognition in order to use voice-operated features of the online social network), and further specify that such voice recording may not be shared with any third-party system 170 or used by other processes or applications associated with the social-networking system 160.

### Miscellaneous

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by one or more computing systems:
accessing an image comprising privacy-sensitive information;
generating a plurality of base descriptors for the image;
encoding, by an encoder trained based on adversarial learning, the plurality of base descriptors into a plurality of content-concealing descriptors, wherein the plurality of content-concealing descriptors are configured to prevent a reconstruction of the privacy-sensitive information; and
executing one or more tasks based on the plurality of content-concealing descriptors.

2. A method comprising, by one or more computing systems:
detecting, based on visual data captured by a client system, a real-world text string, wherein the visual data depicts a field of view of a user associated with the client system;
determining, based on sensor data from the client system, an indication of a difficulty of the user viewing the real-world text string;
determining, based on one or more machine-learning models, a rendering of the real-world text string, wherein the rendering alternates an visual appearance of the real-world text string; and
sending, to the client system, instructions for presenting the rendering of the real-world text string in the field of view of the user.

3. A method comprising, by one or more computing systems:
receiving, from a head-mounted device associated with a first user, one or more signals captured by the head-mounted device, wherein the one or more signals comprise one or more audio signal corresponding to a voice input from the first user and one or more visual signals corresponding to eye movements from the first user;
determining, based on the one or more visual signals by one or more eye-tracking algorithms, a gaze of the first user;
determining, based on the one or more audio signals, an intent from the first user;
executing, based on the intent and the gaze of the first user, one or more tasks;
generating a communication content responsive to the voice input based on execution results of the one or more tasks; and
sending, to the head-mounted device, instructions for presenting the communication content.
